(19) United States
(12) Patent Application Publication
(10) Pub. No.: US 2009/0070042 A1
(43) Pub. Date: Mar. 12, 2009

(54) JOINT INVERSION OF BOREHOLE ACOUSTIC RADIAL PROFILES FOR IN SITU STRESSES AS WELL AS THIRD-ORDER NONLINEAR DYNAMIC MODULI, LINEAR DYNAMIC ELASTIC MODULI, AND STATIC ELASTIC MODULI IN AN ISOTROPICALLY STRESSED REFERENCE STATE

(76) Inventors: Richard Birchwood, Houston, TX (US); Saad Kisra, Ville d'Avray (FR)

Correspondence Address: SCHLUMBERGER INFORMATION SOLUTIONS, 5599 SAN FELIPE, SUITE 1700, HOUSTON, TX, 77056-2722, US

(21) Appl. No.: 12/199,243

(22) Filed: Aug. 27, 2008

Related U.S. Application Data
(60) Provisional application No. 60/971,529, filed on Sep. 11, 2007.

(51) Int. Cl. G01V 1/40

(52) U.S. Cl. 702/11

(57) ABSTRACT

A computer-implemented method of estimating mechanical properties and stresses of rocks around a borehole. In situ stresses and dynamic and static moduli of a rock are jointly inferred from acoustic radial profiles measured with a borehole sonic tool. Inversion is performed on equations that govern the near-borehole distributions of the compressional wave slowness, the fast shear wave slowness, the slow shear wave slowness, and the shear wave modulus in the plane perpendicular to the borehole axis for in situ stresses, the dynamic shear modulus, the dynamic Lamé parameter, λ, the static drained Young's modulus, and the static drained Poisson's ratio. Third-order nonlinear dynamic moduli are also inferred by the procedure. Material properties are retrieved in an isotropically stressed reference state. The input data used by the inversion is appropriately prescribed. Methods for constraining the solution in the event of noisy or limited data are demonstrated.

### RELATED APPLICATION

This application claims priority to U.S. Provisional Application No. 60/971,529, filed on Sep. 11, 2007. This application is related to U.S. application Ser. No. 11/821,541, attorney docket number 110.0143, filed on Jun. 22, 2007.

### BACKGROUND OF THE INVENTION

1. Field of the Invention

The present invention relates generally to an improved data processing system and in particular to a method and apparatus for determining parameters that govern stress and deformation in rocks. More particularly, the present invention relates to a computer implemented method, apparatus, and a computer usable program product for jointly inferring in situ stresses and dynamic and static moduli of a rock from acoustic radial profiles measured with a borehole sonic tool.

2. Background of the Invention

The mining, oil, and gas industries often drill deep boreholes in the earth's subsurface. The depths of these boreholes can exceed one mile. A number of serious problems can occur when drilling at these depths. For example, the walls of the borehole may collapse or fracture in an undesired manner. Additionally, fluids contained within the pore spaces of rocks, such as oil, gas, or water, may be at a high pressure and may invade the borehole and erupt explosively on the surface.

One method to prevent borehole collapse or unwanted fluid invasion is to circulate mud through the borehole during drilling. If the density of the mud is sufficiently high, the pressure of the mud will exceed the pore pressure and no fluid invasion will occur. The mud also provides support to the borehole wall and prevents collapse from occurring. Circulation of mud cools the borehole and transports rock fragments produced by the drilling process to the surface. However if the density of the mud is too high, the borehole may fracture, resulting in loss of mud to the surrounding rocks. Such mud losses can lead to premature abandonment of the well, due to the inability of the driller to control the circulation of mud in the borehole.

In order to determine the proper density of the mud to be used, the internal stresses of rocks in the vicinity of the borehole must be determined. The stresses near the borehole (near-wellbore stresses) are perturbed in relation to those far away from the borehole (far-field stresses). In order to estimate the near-wellbore stresses, the far-field stresses, as well as material properties of the rock, referred-to as static elastic moduli, are measured, calculated, or estimated. The static elastic moduli determine the amount of elastic deformation that occurs in rocks in response to constant or slowly varying loads or forces.

In contrast, dynamic elastic moduli control the elastic response of the rock to rapidly varying loads or forces. The dynamic elastic moduli can be used to infer the pressure of fluids in the pore spaces of rocks (pore pressure). Knowledge of pore pressure is used to select the proper mud density. The third-order nonlinear dynamic moduli are proportionality constants that relate changes in acoustic wave speed to changes in rock deformation. The importance of third-order nonlinear dynamic moduli lies in the fact that these moduli are used to deduce the stress state of a rock from its acoustic properties.

In order to boost production from oil and gas reservoirs, the borehole is sometimes deliberately fractured using fluids pumped into the borehole at high pressure. Fractures created in this manner are known as “hydraulic fractures” and, when properly designed, propagate away from the borehole into the reservoir. The hydraulic fractures create conduits that allow hydrocarbons to flow to the borehole. The internal stresses and static elastic moduli of rocks are important inputs to hydraulic fracture design models used to calculate the forces to be applied to deliberately fracture the borehole and the subsequent geometry of the fracture. Thus, knowledge and mechanisms for determination of parameters that govern stress and deformation in rocks surrounding a borehole is desirable. Other models using knowledge of these parameters include those models used to predict subsidence (which is vertical compaction of rock mass caused by removal of oil, gas, or water from the subsurface) and solids production (which is contamination of produced hydrocarbons with rock particles extracted from the producing zone by excessive rock and fluid forces).

Improvements can also be made to a borehole based on determined parameters of the rock surrounding the borehole. For example, a metal casing can be inserted into the borehole, where the metal casing has a radius slightly less than the radius of the borehole. Cement is then pumped down the inside of the casing and then out the bottom of the casing and up into the space between the casing and the borehole wall (the “casing annulus”). The casing, cement, and other equipment so installed in order to facilitate production are known as completions equipment. The metal casing and cement are thereafter perforated with explosives at select depths in order to allow hydrocarbons in the rock to flow into the well. The perforation tunnels may extend several feet into the rock formation.

As hydrocarbons are produced, the internal stresses in the rocks may change, leading to mechanical failure of the perforations. The rock fragments produced by such failure may be drawn into the well along with the produced fluids, thereby resulting in solids production. Produced solids increase production costs by eroding pipes and other hydraulic equipment, and by possibly requiring the use of special measures for filtration and disposal of the solids. Thus, again, the internal stresses and static elastic properties of the rocks near the borehole are important inputs for modeling the conditions for failure of perforation tunnels.

Changes in the internal stresses in rocks that occur during production may also cause rocks to compact, that is, subside. Completions equipment bonded to the rock mass, such as casing, liners, packers, and others, will move with the earth. As a result, completions equipment may undergo severe strains and eventually fail. Prediction of subsidence and effects of subsidence on the integrity of completions equipment uses knowledge of the internal stresses and static elastic properties of rocks.

The internal stresses in rocks can be expressed as three mutually perpendicular principal stresses. In the far-field, these three mutually perpendicular principle stresses consist, in the simplest cases, of a vertical stress and two horizontal stresses. The vertical stress is caused by the weight of overlying rock. The two horizontal stresses are known as the maximum horizontal stress and the minimum horizontal stress. The spatial distribution of stresses on the rock is known as a stress field. When the stress field is complex, the three principal far-field stresses might not be vertical or horizontal, but they are still mutually perpendicular to one another. When the three principal stresses are equal, the stress field is said to be isotropic.

To date, no method exists for measuring the in situ static elastic moduli and the dynamic elastic moduli in an isotropic reference state of a rock. The term in situ refers to the location of the borehole itself. Thus, no current method exists for measuring these properties of a borehole at the borehole itself. Instead, core samples are conventionally extracted from the subsurface and sent to a laboratory for analysis. However, extraction of core is costly and may damage the rock sample, leading to erroneous results.

### SUMMARY OF THE INVENTION

The illustrative embodiments described herein provide for a computer-implemented method of modeling a rock formation. At least one static elastic property of material surrounding the borehole is determined in situ. The stresses and strains in the rock are modeled based on the static elastic property. This geomechanics model is then stored in a memory of a data processing system. The geomechanics model can be used to improve drilling and production operations.

The illustrative embodiments described herein also provide for a computer-implemented method of modeling a rock formation. Specifically, the illustrative embodiments involve inferring dynamic and static elastic properties in an isotropic reference state using measurements of a sonic measuring tool. Such properties are used to measure stress and pore pressure in a rock formation. This illustrative embodiment can further include acquiring at least one radial profile of the material. This illustrative embodiment can further include inverting the at least one radial profile to estimate at least one static elastic property and the at least one dynamic elastic property of the material in an isotropic reference state.

The illustrative embodiments described herein also provide for a computer-implemented method of determining stresses around a borehole of a well using a scheme that jointly infers static and dynamic properties in an isotropic reference state rather than assuming them to be known as in previous inversion schemes for stress. A first set of equations is prepared for one or more compressional radial profiles, a second set of equations is prepared for one or more shear radial profiles, and a third set of equations is prepared for one or more c₆₆ radial profiles. The first, second, and third sets of equations all adhere to the form

$$y = α + \frac{β}{{x}^{2}} + \frac{γ}{{x}^{4}} \qquad ( 1 )$$

The term y represents the measured compressional wave speed, shear wave speed, or c₆₆ value. The term “x” is equal to the dimensionless radius (r/R), where “r” is the radial distance from the center of the borehole and “R” is the radius of the borehole. The terms α, β, and γ are coefficients of sequential powers (1/x²). If fast and slow compressional radial profiles, fast and slow shear radial profiles, and fast and slow c₆₆ profiles are known, nine independent equations can be constructed for 10 unknown variables at each depth location in the borehole by finding the values of α, β, and γ that best match the compressional radial profiles, the shear radial profiles, and the c₆₆ radial profiles. One or more of the 10 unknown variables is prescribed either exactly or inexactly by, for example, using bounds, probability density functions, or other techniques. The unknown variables are estimated using the 9 independent equations. The estimated variables are stored in a memory of a data processing system.

In an illustrative embodiment, the first, second, and third sets of equations are derived from the elastic solution for stresses around a borehole. Furthermore, in addition to the 9 equations, 7 equations can be constructed for the 10 unknown variables. However, these equations are not independent of the other 9 equations. In any case, the rock formation can be modeled using one or more prescribed variables and at least one of the estimated variables. The resulting geomechanics model can be used to improve drilling and production.

As an alternative to explicitly constructing 9 independent equations, the unknown variables can be solved directly by matching modeled and measured compressional, shear, and c₆₆ radial profiles. This method discards the intermediate step of finding the values of α, β, and γ, and is especially convenient if the data is noisy and a stochastic inversion scheme is used to solve for the unknowns. In this case, the sensitivity of the unknown variables to noise can be assessed directly. However, the number of independent equations is unchanged by the use of such procedures.

In the event that 9 independent equations cannot be constructed at each depth location in the borehole due to data acquisition or other limitations, additional equations or constraints can be found in order to solve for the 10 unknowns. Examples of such equations or constraints include empirical relations between dynamic and static moduli; relations between the far-field principal stresses based on empirical or theoretical models; the use of contact theories to reduce the number of independent parameters; additional equations obtained by changing the borehole mud pressure; and assumptions about the spatial structure of rock properties along the borehole trajectory expressed using geostatistical, or other methods. For example, if a rock layer is reasonably uniform over a given depth interval, the ratio of independent equations to unknown variables may be increased by jointly inverting two sets of radial profiles at two depth levels in the layer. Those skilled in the art would appreciate that the above suggestions are provided for exemplary purposes only and, accordingly, should not be construed as limiting the scope of the invention.

Additionally, aspects of the illustrative embodiments use borehole acoustic radial profiles of compressional wave slowness, a fast shear wave slowness, a slow shear wave slowness, and a shear wave slowness in the plane perpendicular to the borehole to infer in situ stresses and material properties, such as the dynamic shear modulus, the dynamic Lamé parameter, λ, the static drained Young's modulus, the static drained Poisson's ratio, and three third order non-linear dynamic moduli of a rock formation. Material properties are retrieved in an isotropic stress state even when the in situ stresses are non-hydrostatic. Additionally, radial profiles are inverted directly for the elastic moduli. Thus, the methods and devices described herein are not dependent on laboratory measurements of core samples or correlations derived therefrom.

Features and advantages of the present invention will become apparent to those of skill in the art by reference to the figures, the description that follows, and the claims.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which aspects of the illustrative embodiments may be implemented;

FIG. 2 is a block diagram of a data processing system in which aspects of the illustrative embodiments may be implemented;

FIG. 3 illustrates a drilling mechanism drilling a borehole into the ground, in accordance with an illustrative embodiment;

FIG. 4 shows a cross section of a borehole, in accordance with an illustrative embodiment;

FIG. 5 is a graph of fast and slow radial profiles of compressional slowness, in accordance with an illustrative embodiment;

FIG. 6 is a graph illustrating fast and slow radial profiles of shear slowness, in accordance with an illustrative embodiment;

FIG. 7 is a graph illustrating fast and slow radial profiles of c₆₆, in accordance with an illustrative embodiment;

FIG. 8 is a graph showing results of deterministic inversion of exact data for two dynamic elastic properties, in accordance with an illustrative embodiment;

FIG. 9 is a graph illustrating results of deterministic inversion of exact data for the static Poisson's ratio, in accordance with an illustrative embodiment;

FIG. 10 is a graph illustrating results of deterministic inversion of exact data for three third-order nonlinear dynamic moduli, in accordance with an illustrative embodiment;

FIG. 11 is a graph illustrating results of deterministic inversion of exact data for stresses and the static Young's modulus, in accordance with an illustrative embodiment;

FIG. 12 is a table illustrating comparison of true and estimated values, in accordance with an illustrative embodiment;

FIG. 13 is a graph illustrating sample distributions for a dynamic Lamés constant derived from probabilistic inversion of noisy radial profile data, in accordance with an illustrative embodiment;

FIG. 14 is a graph illustrating sample distributions for the dynamic shear modulus derived from probabilistic inversion of noisy radial profile data, in accordance with an illustrative embodiment;

FIG. 15 is a graph illustrating sample distributions for static drained Poisson's ratio derived from probabilistic inversion of noisy radial profile data, in accordance with an illustrative embodiment;

FIG. 16 is a graph illustrating sample distributions for static drained Young's modulus derived from probabilistic inversion of noisy radial profile data, in accordance with an illustrative embodiment;

FIG. 17 is a table illustrating actual and inferred properties at two different depths for various physical constants and stresses related to a rock formation, in accordance with an illustrative embodiment;

FIG. 18 is a graph illustrating radial profiles of shear slowness at a first depth, in accordance with an illustrative embodiment;

FIG. 19 is a graph illustrating radial profiles of shear slowness at a second depth, in accordance with an illustrative embodiment;

FIG. 20 is a table illustrating compressional wave slownesses and c66 values at two different depths, in accordance with an illustrative embodiment;

FIG. 21 is a graph illustrating sample distributions for Lamé's constant derived from probabilistic inversion of noisy radial profile data, in accordance with an illustrative embodiment;

FIG. 22 is a graph of sample distributions for the dynamic shear modulus derived from probabilistic inversion of noisy radial profile data, in accordance with an illustrative embodiment;

FIG. 23 is a graph illustrating sample distributions for the static Poisson's ratio derived from probabilistic inversion of noisy radial profile data, in accordance with an illustrative embodiment;

FIG. 24 is a graph illustrating sample distributions for the static Young's modulus derived from probabilistic inversion of noisy radial profile data, in accordance with an illustrative embodiment;

FIG. 25 is a graph illustrating sample distributions for the vertical stress at a first depth derived from probabilistic inversion of noisy radial profile data, in accordance with an illustrative embodiment;

FIG. 26 is a graph illustrating sample distributions for the maximum horizontal stress at a first depth derived from probabilistic inversion of noisy radial profile data, in accordance with an illustrative embodiment;

FIG. 27 is a graph illustrating sample distributions for the minimum horizontal stress at a first depth derived from probabilistic inversion of noisy radial profile data, in accordance with an illustrative embodiment;

FIG. 28 is a graph illustrating sample distributions for the maximum horizontal stress at a second depth derived from probabilistic inversion of noisy radial profile data, in accordance with an illustrative embodiment;

FIG. 29 is a graph illustrating sample distributions for the minimum horizontal stress at a second depth derived from probabilistic inversion of noisy radial profile data, in accordance with an illustrative embodiment;

FIG. 30 is a graph illustrating sample distributions for the non-linear dynamic modulus c₁₁₁ derived from probabilistic inversion of noisy radial profile data, in accordance with an illustrative embodiment;

FIG. 31 is a graph illustrating sample distributions for the non-linear dynamic modulus c₁₄₄ derived from probabilistic inversion of noisy radial profile data, in accordance with an illustrative embodiment;

FIG. 32 is a graph illustrating sample distributions for the non-linear dynamic modulus c₁₅₅ derived from probabilistic inversion of noisy radial profile data, in accordance with an illustrative embodiment;

FIG. 33 is a flowchart illustrating a method of using a model of a borehole to determine and implement production improvements for the borehole, in accordance with an illustrative embodiment;

FIG. 34 is a flowchart illustrating a method of modeling the pore pressure in a rock formation, in accordance with an illustrative embodiment; and

FIG. 35 is a flowchart illustrating a method of determining at least one static elastic property and at least one dynamic elastic property in an isotropic reference state, in accordance with an illustrative embodiment.

### DETAILED DESCRIPTION OF THE DRAWINGS

In the following detailed description of the preferred embodiments and other embodiments of the invention, reference is made to the accompanying drawings. It is to be understood that those of skill in the art will readily see other embodiments and changes may be made without departing from the scope of the invention.

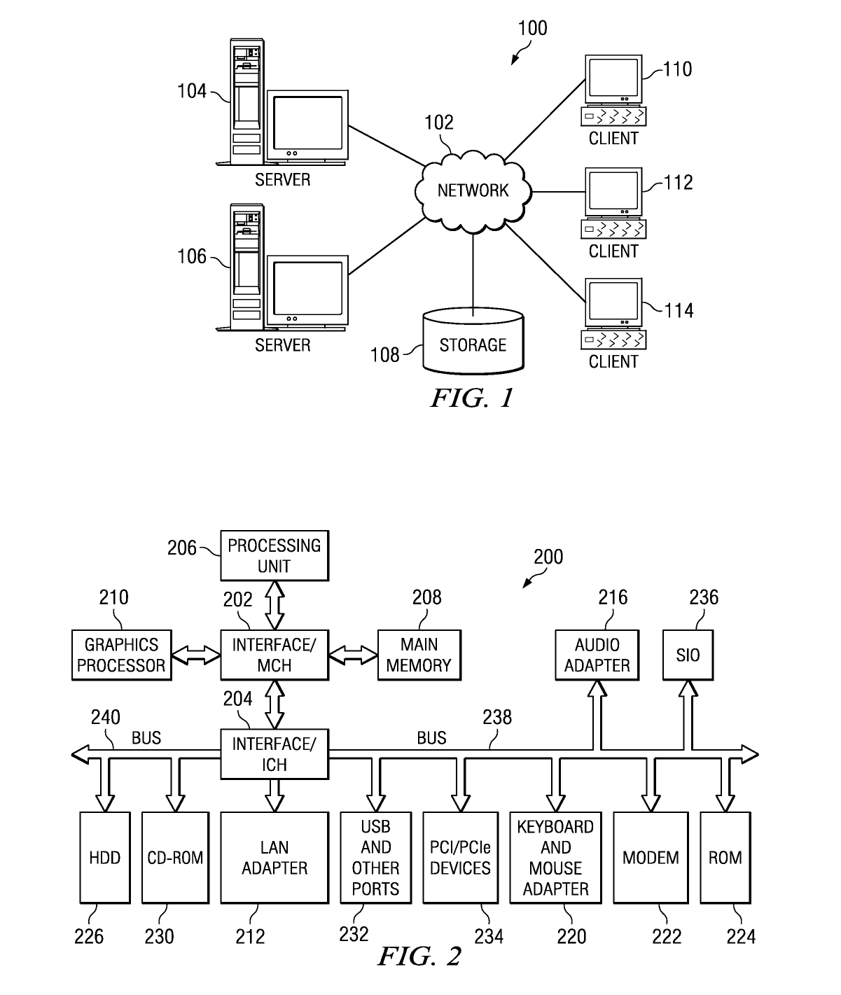

With reference now to the figures and in particular with reference to FIGS. 1-2, exemplary diagrams of data processing environments are provided in which illustrative embodiments may be implemented. FIGS. 1-2 are only exemplary and are not intended to assert or imply any limitation with regard to the environments in which different embodiments may be implemented. Many modifications to the depicted environments may be made.

FIG. 1 is pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system, such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache, such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention deal with inference of the dynamic elastic moduli and the third-order nonlinear dynamic moduli. In general, both quantities are stress-dependent. In an illustrative embodiment, both quantities are inferred in an isotropically stressed reference state.

The dynamic elastic moduli can be used to infer the pressure of fluids in the pore spaces of rocks (pore pressure). By inferring the dynamic elastic moduli in an isotropically stressed reference state, confounding effects due to a complex stress field can be removed. Knowledge of pore pressure is used to determine proper mud density selection.

The third-order nonlinear dynamic moduli are proportionality constants that relate changes in acoustic wave speed to changes in rock deformation. The importance of third-order nonlinear dynamic moduli lies in the fact that these moduli are used to deduce the stress state of a rock from its acoustic properties.

The illustrative examples described herein use borehole acoustic radial profiles of compressional wave slowness, the fast shear wave slowness, the slow shear wave slowness, and the shear wave slowness in the plane perpendicular to the borehole axis to infer in situ stresses, the dynamic shear modulus, the dynamic Lamé parameter, λ, the static drained Young's modulus, the static drained Poisson's ratio, and three third order non-linear dynamic moduli of a rock formation. Material properties are retrieved in an isotropic stress state, even when the in situ stresses are non-hydrostatic. The method inverts radial profiles directly for the elastic moduli and is not dependent on laboratory measurements on core samples or correlations derived therefrom. The inversion procedure is supported by a theory, provided herein, that specifies the conditions for uniqueness of the solution.

Thus, the methods and devices described herein provide for a method of determining and/or inferring various parameters of rock surrounding a borehole. A geomechanical model of the formation can be created using these parameters. Using this model, the stability of the borehole wall can be determined in situ. A selected density of mud to be used to fill the borehole can be determined, thereby ensuring that the borehole is properly supported and that mud losses due to hydraulic fracturing do not occur. Models of hydraulic fracturing, sand production, and rock subsidence can also be derived from the geomechanical model.

In a specific illustrative embodiment, a method of determining stresses and material properties around a vertical borehole of a well includes the following steps. First, equations are prepared for compressional radial profiles, shear radial profiles, and c₆₆ radial profiles which adhere to the form:

$$y = α + \frac{β}{{x}^{2}} + \frac{γ}{{x}^{4}} ,$$

where y represents the measured compressional wave speed, shear wave speed, or c₆₆ value; x is a dimensionless radius (r/R) and α, β and γ are coefficients of sequential powers of

$$( \frac{1}{{x}^{2}} ) .$$

Thereafter, 9 independent equations for the unknowns are constructed by finding the values of α, β, and γ that best match the radial profiles. Because a total of ten unknown variables exist, the method includes specifying one or more of the unknown variables either exactly or imprecisely, and then solving for the unknown variables.

In another illustrative embodiment, the equations for compressional radial profiles, shear radial profiles, and c₆₆ radial profiles are derived from the elastic solution for stress around a vertical borehole. In an illustrative example, the compressional radial profile takes the form

$$Vp ( r , θ ) = \sqrt{\frac{λ + 2 μ}{ρ}} [ \begin{matrix}1 + \frac{\begin{matrix}( 1 + v ) ( {σ}_{h} + {σ}_{H} - 2 {σ}_{v} ) \\ ( 2 {c}_{155} + 5 μ + 2 λ )\end{matrix}}{3 E ( λ + 2 μ )} + \\ \frac{\begin{matrix}( {c}_{111} - 4 {c}_{155} - 2 μ ) ( 1 + v ) \\ ( 2 v - 1 ) ( {σ}_{h} - {σ}_{H} ) Cos ( 2 θ )\end{matrix}}{E ( λ + 2 μ )} \frac{{R}^{2}}{{r}^{2}}\end{matrix} ] ;$$

The equation for the shear radial profile takes the form

$$Vs ( r , θ ) = \sqrt{\frac{μ}{ρ}} [ \begin{matrix}1 + \frac{( 1 + v ) [ \begin{matrix}( {c}_{155} - {c}_{144} + 6 μ ) ( {σ}_{h} + {σ}_{H} - 2 {σ}_{v} ) + \\ ( 3 {c}_{155} - 3 {c}_{144} + 6 μ ) ( {σ}_{h} - {σ}_{H} ) Cos ( 2 θ )\end{matrix} ]}{12 μ E} + \\ \frac{( 1 + v ) [ \begin{matrix}( {c}_{155} - {c}_{144} + 2 μ ) ( {σ}_{h} + {σ}_{H} - 2 {p}_{mud} ) + \\ 4 ( {c}_{144} v - {c}_{155} ( 1 - v ) - μ - λ ( 1 - 2 v ) ) \\ ( {σ}_{h} - {σ}_{H} ) Cos ( 2 θ )\end{matrix} ]}{4 μ E} \frac{{R}^{2}}{{r}^{2}} + \\ \frac{3 ( - {c}_{144} + {c}_{155} + 2 μ ) ( 1 + v ) ( {σ}_{h} - {σ}_{H} ) Cos ( 2 θ )}{4 μ E} \frac{{R}^{4}}{{r}^{4}}\end{matrix} ] , and$$

the equation for the c₆₆ radial profile takes the form

$${c}_{66} ( r , θ ) = μ - \frac{( 1 + v ) [ \begin{matrix}( {c}_{155} - {c}_{144} + 3 μ ) ( {σ}_{h} + {σ}_{H} - 2 {σ}_{v} ) - \\ 3 μ ( {σ}_{h} - {σ}_{H} ) Cos ( 2 θ )\end{matrix} ]}{3 E} - \frac{( 1 + v ) [ \begin{matrix}- μ ( {σ}_{h} + {σ}_{H} - 2 {p}_{mud} ) + \\ ( 2 {c}_{155} + 2 λ ( 1 - 2 v ) + 8 μ - 4 {c}_{155} v - 12 μ v ) \\ ( {σ}_{h} - {σ}_{H} ) Cos ( 2 θ )\end{matrix} ]}{E} \frac{{R}^{2}}{{r}^{2}} + \frac{3 ( 1 + v ) μ ( {σ}_{h} - {σ}_{H} ) Cos ( 2 θ )}{E} \frac{{R}^{4}}{{r}^{4}}$$

These equations were derived by substituting the strains computed using the elastic solution for stress around a borehole into the equations of third-order non-linear elasticity and expanding to first order in strain. In these equations, Vp(r,θ), Vs(r,θ), and c₆₆(r,θ) are the compressional wave velocity, shear wave velocity, and c₆₆ modulus expressed as functions of the radial distance, r, from the borehole centerline and the azimuth angle, θ, as measured relative to the azimuth of the maximum horizontal stress. Additionally, X is the dynamic Lamé's constant, μ is the dynamic shear modulus, ρ is the bulk density, ν is the static drained Poisson's ratio, E is the static drained Young's modulus, and σ_{V}, σ_{H}, and σₕ are the vertical stress, maximum horizontal stress, and minimum horizontal stress respectively. Moduli c₁₁₁, c₁₄₄, and c₁₅₅ are third order non-linear elastic constants. R and P_{mud} is the borehole radius and mud pressure, respectively.

As used herein, the quantities “c” followed by subscripts refers to various moduli or stiffness constants of the rock. For example, quantities with two subscripts in the form of cᵢⱼ are known as elastic stiffness constants and are defined well in the art. The elastic stiffness constants are abbreviations of fourth order tensors possessing four subscripts i, j, k, and l. A convention defined in the art is used to collapse the number of subscripts from four to two. The quantities with three subscripts, such as, c₁₁₁, c₁₄₄, and c₁₅₅, are known as non-linear dynamic moduli and are abbreviations of sixth order tensors of the form cᵢⱼₖₗₘₙ. The convention described in the art is used to collapse the number of subscripts from six to three. The tensor cᵢⱼₖₗₘₙ is defined by the following partial derivative: cᵢⱼₖₗₘₙ=d(cᵢⱼₖₗ)/d(eₘₙ), where eₘₙ is the strain tensor (m and n are subscripts), temperature and all other strains are held constant, and cᵢⱼₖₗ is the elastic stiffness constant. Thus, cᵢⱼₖₗₘₙ measures the sensitivity of the elastic stiffness constants to strain.

In the illustrative embodiments described herein, inferred values can be used to model the stresses and strains in the vicinity of a borehole. The borehole model can be used to determine and implement drilling and production improvements for the well. In part, drilling improvements include the use of mud of a determined weight to support the walls of the borehole during drilling. In part, production improvements for the well include perforating the well, and deliberately introducing fractures into the sides of the borehole in order to cause additional fluid to flow from the rock into the borehole. Other production improvements can also be implemented based on the parameters determined according to the illustrative embodiments described herein.

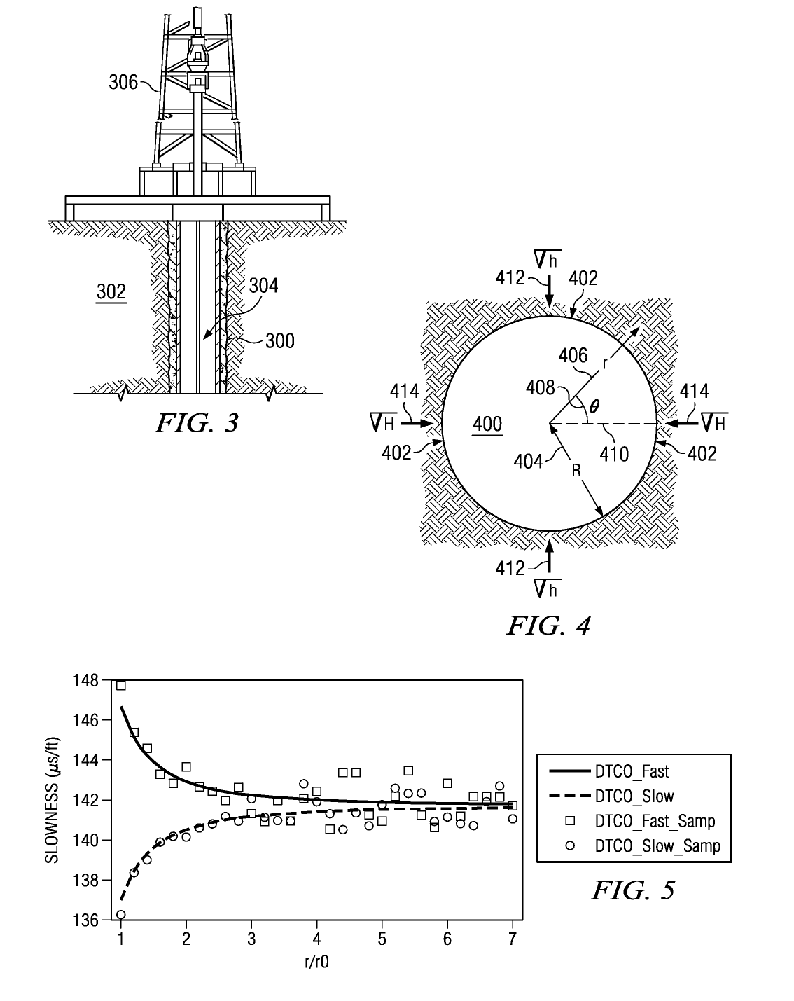

FIG. 3 illustrates a drilling mechanism drilling a borehole into the ground, in accordance with an illustrative embodiment. Various aspects of the drilling operation shown in FIG. 3 can be connected to one or more data processing systems, such as data processing system 100 shown in FIG. 1 and data processing system 200 shown in FIG. 2. For example, a measuring instrument, such as a sonic measuring tool can be inserted into borehole 300 in order to measure various properties regarding the rock surrounding borehole 300. Similarly, sensors or mechanical devices can be attached to a drilling tool 304 or platform 306 in order to measure various aspects of the drilling operation. These sensors or mechanical devices can be connected to a data processing system, such as data processing system 100 in FIG. 1, or data processing system 200 in FIG. 2.

FIG. 3 illustrates an overview of a drilling operation. Borehole 300 extends deep beneath ground 302. Although the depth of borehole 300 can be any particular depth, and thus could be as shallow as a few feet, the depth of borehole 300 can exceed a mile or more for many petroleum industry applications. Borehole 300 is drilled with drilling tool 304, which in turn is supported by platform 306.

FIG. 4 shows a cross section of a borehole, in accordance with an illustrative embodiment. FIG. 4 is a cross section of borehole 300 shown in FIG. 3.

The cross-section shown in FIG. 4 can be taken at any particular point or plane along the length of a borehole. Borehole 400 includes borehole wall 402. Borehole wall 402 is formed from rock surrounding borehole 400. Borehole wall 402 can be modeled by various parameters. For example, the borehole can have a radius, R, represented by arrows 404. Arrow 406, designated as “r”, represents a radial direction used in polar coordinates. Angle θ 408 represents the angle between a reference line 410 and the arrows represented by “r”. Other parameters include σₕ 412, which represents the minimum horizontal stress applied to the borehole wall and σ_{H} 414, which represent the maximum horizontal stress on the borehole wall. Note that various features and parameters of borehole 400 can be modeled using other parameters not necessarily shown in FIG. 4, such as Young's modulus, Poisson's ratio, and other properties of borehole 400, or of the material surrounding the borehole.

The parameters of borehole 400 should be estimated in order to model the stresses that act upon borehole wall 402. The model of the stresses is used to analyze the stability of the borehole wall and to predict conditions under which the borehole will fail. Specifically, the knowledge of when a borehole wall will collapse or fracture when mud of a particular density is introduced into the borehole is useful knowledge. If at a proper density, the mud helps prevent borehole collapse.

Stress is mathematically modeled as a tensor. The stress tensor is a mathematical construct with six independent components. In the illustrative embodiments described herein, the orientation of the tensor is changed so that the six independent components collapse to three components known as the principal stresses. The six stress components can be obtained for any orientation of the stress tensor when the magnitudes and orientations of the three principal stresses are known. In the simplest cases, the three principal stresses are the vertical stress, which is equal to the weight of the overlying rock, and two horizontal stresses, i.e., the maximum horizontal stress and minimum horizontal stress.

The illustrative embodiments described herein provide a method to estimate the magnitudes of the three principal stresses based on measurements taken by a sonic tool. The sonic tool measures the speed of acoustic waves in the rock, as well as other properties of the rock. Static elastic properties of the rock surrounding the borehole are estimated in conjunction with the principal stresses. Static elastic properties are those properties that are obtained when the rock is subjected to constant or slowly varying loads. This kind of loading occurs, for example, when a rock is compressed using a compression device in a laboratory. An example of a compression device is a triaxial loading machine. In contrast, dynamic elastic properties are obtained when the rock is subject to rapidly varying loads. For example, when an acoustic wave generated by a sonic tool propagates through a rock, the rock is subject to rapidly varying loads of an oscillatory nature.

Conventionally, a sonic tool could be used to obtain the dynamic elastic properties of a rock. However, the static elastic properties of a rock, in the prior art, had to be obtained by transporting a sample of the rock surrounding the borehole to a laboratory. The laboratory would then apply slow forces to the rock in order to determine the static elastic properties. However, this method of determining the static elastic properties is not ideal, not only because the expense and time that is required, but also because the core samples of the rock surrounding the borehole might not behave in the same way as the actual rock surrounding the borehole due to damage incurred during the coring process.

The illustrative embodiments described herein provide a method for determining the static elastic properties of the rock from radial profiles measured with the sonic tool. In other words, the illustrative embodiments described herein provide a method of obtaining a direct measurement of the static elastic properties of the rock, using radial profiles measured with an acoustic tool. Thus, the illustrative embodiments described herein provide a method for in situ modeling of stresses and other parameters of rock surrounding a borehole.

Stated differently, the illustrative embodiments described herein provide a method to jointly infer in situ stresses and dynamic and static moduli of a rock from acoustic radial profiles measured with a borehole sonic tool. The illustrative embodiments invert the equations that govern the near wellbore distributions of the compressional wave slowness, the fast shear wave slowness, the slow shear wave slowness, and the shear wave slowness in the plane perpendicular to the borehole axis for in situ stresses. The method also inverts these equations for the dynamic shear modulus, the dynamic Lamé parameter, λ, the static drained Young's modulus, and the static drained Poisson's ratio. Third order non-linear dynamic moduli are also inferred by the procedure. The terms “third order non-linear dynamic moduli” and “third order non-linear elastic constants” are used interchangeably herein. Material properties in the illustrative embodiments are retrieved in an isotropically stressed reference state. The illustrative embodiments also provide a theory that describes the conditions for uniqueness of the inversion to ensure that the input data used by the inversion is appropriately prescribed.

Knowledge of static elastic moduli is important for modeling the deformation and failure of rocks. These properties are widely used within the petroleum industry to model borehole stability, hydraulic fracturing, sand production, and subsidence. However, estimating values that are representative of the in situ conditions of rocks has proven to be difficult. Dynamic elastic properties could be obtained directly from seismic or downhole acoustic data; however, no theoretical method exists to convert such measurements to static quantities.

Laboratory measurements can be performed on core samples, but the reliability of the results is compromised by various problems. Core samples of rock undergo damage during the extraction process which affects the mechanical properties. The static Poisson's ratio is notoriously difficult to measure in the lab and inconsistent results are frequently obtained. These inconsistencies may be physical in origin or may be due to measurement errors caused by scaling and size effects and bulging of the sample at mid height, a phenomenon known as barreling. Additionally, compliance mismatches between the sample sleeve, rock, and measurement device can cause measurement errors.

Once acquired, results from laboratory tests are applied to predict in situ properties. Correlations based upon ultra-sonic wave measurements are often derived for this purpose. However, these correlations can contain significant scatter or uncertainty. Correlations are only applicable to the formations from which the cores were obtained. When the correlations are applied elsewhere, the reliability of the correlations is often difficult or impossible to establish. Problems in applying correlations are compounded by incompatibility between laboratory and in situ acoustic velocities.

In order to compare ultra-sonic velocities measured in a laboratory with acoustic velocities measured in situ, corrections for the effects for fluid content scaling and velocity dispersion should be made. For example, flow in micro-cracks in core samples can cause ultra-sonic velocities to be significantly higher than similar velocities measured in situ at lower frequencies. This effect occurs particularly at low effective stress levels. However, corrections for these types of effects are seldom made in practice. The illustrative embodiments described herein reduce or eliminate the problems described above by relying solely in situ measurements.

The dynamic shear modulus and the dynamic Lamé parameter, λ, are referenced to an isotropic stress state. From these properties, compressional wave (p-wave) and shear wave (s-wave) velocities in the reference stress state can be inferred if the density of the rock is known. Such velocities can be referred to as stress normalized velocities (SNV's). The advantage of stress normalized velocities is that their dependence on stress can be expressed using a single scalar measure of stress, such as the effective reference confining pressure. In contrast, conventional p-wave and s-wave velocities are referred to as the in situ stress state of the medium and are, in general, functions of the full six component stress tensors.

In complex stress environments, such as near faults, folds, or salt domes, stress normalized velocities should be easier to interpret than conventional velocities. For example, acoustic velocity at two locations having different stress tensors can be compared by normalizing them to the same reference confining pressure. Then, the difference in acoustic velocities can be attributed to factors other than stress, such as variations in methodology, pore pressure, or fluid content.

Failure to recognize the dependence of acoustic velocities on the full stress tensor can lead to errors, particularly in complex stress environments. The presence of errors is particularly problematic in pore pressure prediction, where acoustic velocities are conventionally assumed to be scalar functions of stress, most often the effective vertical stress. This assumption is frequently applied without regard to the prevailing stress field. However, it has been shown that the use of the effective vertical stress can lead to significant underestimation of the pore pressure in extensional basins in Southeast Asia.

A possible method of accounting for this underestimation is to replace the vertical stress with the mean confining stress. However, this approach also ignores the dependence of acoustic velocity on the full stress tensor. A more rigorous procedure, made possible by the illustrative embodiments described herein, is to estimate the acoustic velocity in an isotropically stressed reference state prior to conducting pore pressure analysis. The acoustic velocity can then be expressed as a function of the effective reference confining pressure. Pore pressure prediction can then proceed using standard techniques.

Techniques for extracting compressional radial profiles, shear radial profiles, and c₆₆ radial profiles from monopole and cross-dipole acoustic measurements are known. Similarly, methods for inferring stress and third order non-linear elastic constants from an inversion of multi frequency acoustic data, from which radial profiles are derived, are also known.

However, these techniques assumed that the static elastic properties of the rock surrounding the borehole were known and equal to their dynamic counterparts. Moreover, dynamic properties measured in the in situ stress state were substituted for those in the isotropic reference state. These assumptions are not accurate, but they make the inversion problem more tractable because they reduce the number of unknowns.

The theory upon which the illustrative embodiments described herein are based does not make any of these assumptions. Instead, dynamic and static elastic properties are inverted as part of the joint inversion scheme that also inverts for stress and the third order non-linear elastic constants. In the illustrative embodiments described herein, the conditions for a well-posed inversion are given by a theory, also provided herein, that prescribes the number of independent equations that could be extracted from radial profiles. From this theory, the precise combination of unknowns that can be uniquely inferred from a given set of input data is determined. The illustrative embodiments also provide methods for building up a sufficient number of equations so that all the unknowns can be solved.

In a specific example, three principal in situ stresses, a dynamic shear modulus, the dynamic Lamé parameter, λ, the static drained Young's modulus, the static drained Poisson's radio, and three third-order non-linear dynamic moduli of the rock formation are deduced in a vertical borehole. The vertical stress is assumed to be a principal stress. However, other combinations of elastic properties including the dynamic Young's modulus, the dynamic Poisson's ratio, static drained bulk modulus, static drained Lamé parameter, λ, and others, can also be acquired using similar techniques. By introducing suitable modifications, the procedures described herein can be applied to deviated or horizontal boreholes and to boreholes that are not aligned with any of the in situ principal stresses.

The theoretical and mathematical bases for the illustrative embodiments are now described. The illustrative methods for deriving rock material properties and stresses from acoustic radial profiles are based on the equations of third-order acoustoelasticity that relate the acoustic impedances (compressional and shear) of a medium subject to stress to material elastic constants (linear and non-linear) and static elastic strains referred to an isotropically stressed reference state. In this non-limiting embodiment, expressions correct to first order in strain for the compressional wave velocity, shear wave velocity, and c₆₆ were derived from the equations of acoustoelasticity (as used herein, the term c₆₆ refers to the modulus of a shear wave propagating in the plane perpendicular to the borehole axis). The strains appearing in these expressions were expressed as functions of the applied stress and static drained elastic properties of the medium using Hooke's law formulated with effective stresses in place of total stresses. This procedure resulted in expressions for the compressional wave velocity, shear wave velocity, and c₆₆ in a medium as functions of applied stress and elastic constants.

Because the stress state in the vicinity of the borehole can be calculated using a variety of methods, such as the elastic solution (based on the Kirsch equations), poroelastic equations, and other methods, the compressional and shear wave velocities and c₆₆ can be calculated as functions of radial distance from the borehole centerline.

Thus, shear radial profiles, compressional radial profiles, and c₆₆ radial profiles can be calculated from knowledge of the in situ stress and the elastic properties of the rock. The inverse problem can be characterized as inferring rock properties and stresses by matching modeled and observed radial profiles.

In an illustrative embodiment, the stresses around the vertical borehole are calculated using an elastic solution, which is based on the Kirsch equations. This results in the following expressions for the compressional radial profile, shear radial profile, and c₆₆ radial profile:

$$\begin{matrix} Vp ( r , θ ) = \sqrt{\frac{λ + 2 μ}{ρ}} [ \begin{matrix}1 + \frac{\begin{matrix}( 1 + v ) ( {σ}_{h} + {σ}_{H} - 2 {σ}_{v} ) \\ ( 2 {c}_{155} + 5 μ + 2 λ )\end{matrix}}{3 E ( λ + 2 μ )} + \\ \frac{\begin{matrix}( {c}_{111} - 4 {c}_{155} - 2 μ ) ( 1 + v ) \\ ( 2 v - 1 ) ( {σ}_{h} - {σ}_{H} ) Cos ( 2 θ )\end{matrix}}{E ( λ + 2 μ )} \frac{{R}^{2}}{{r}^{2}}\end{matrix} ] & ( 2 ) \\ Vs ( r , θ ) = \sqrt{\frac{μ}{ρ}} [ \begin{matrix}1 + \frac{( 1 + v ) [ \begin{matrix}( {c}_{155} - {c}_{144} + 6 μ ) ( {σ}_{h} + {σ}_{H} - 2 {σ}_{v} ) + \\ ( 3 {c}_{155} - 3 {c}_{144} + 6 μ ) ( {σ}_{h} - {σ}_{H} ) Cos ( 2 θ )\end{matrix} ]}{12 μ E} + \\ \frac{( 1 + v ) [ \begin{matrix}( {c}_{155} - {c}_{144} + 2 μ ) ( {σ}_{h} + {σ}_{H} - 2 {p}_{mud} ) + \\ 4 ( {c}_{144} v - {c}_{155} ( 1 - v ) - μ - λ ( 1 - 2 v ) ) \\ ( {σ}_{h} - {σ}_{H} ) Cos ( 2 θ )\end{matrix} ]}{4 μ E} \frac{{R}^{2}}{{r}^{2}} + \\ \frac{3 ( - {c}_{144} + {c}_{155} + 2 μ ) ( 1 + v ) ( {σ}_{h} - {σ}_{H} ) Cos ( 2 θ )}{4 μ E} \frac{{R}^{4}}{{r}^{4}}\end{matrix} ] & ( 3 ) \\ {c}_{66} ( r , θ ) = μ - \frac{( 1 + v ) [ \begin{matrix}( {c}_{155} - {c}_{144} + 3 μ ) ( {σ}_{h} + {σ}_{H} - 2 {σ}_{v} ) - \\ 3 μ ( {σ}_{h} - {σ}_{H} ) Cos ( 2 θ )\end{matrix} ]}{3 E} - \frac{( 1 + v ) [ \begin{matrix}- μ ( {σ}_{h} + {σ}_{H} - 2 {p}_{mud} ) + \\ ( 2 {c}_{155} + 2 λ ( 1 - 2 v ) + 8 μ - 4 {c}_{155} v - 12 μ v ) \\ ( {σ}_{h} - {σ}_{H} ) Cos ( 2 θ )\end{matrix} ]}{E} \frac{{R}^{2}}{{r}^{2}} + \frac{3 ( 1 + v ) μ ( {σ}_{h} - {σ}_{H} ) Cos ( 2 θ )}{E} \frac{{R}^{4}}{{r}^{4}} & ( 4 )\end{matrix}$$

In equations 2, 3, and 4, Vₚ(r,θ), Vₛ(r,θ), and c₆₆(r,θ) are respectively the compressional wave velocity, shear wave velocity, and shear modulus in the plane perpendicular to the borehole axis expressed as functions of the radial distance, r, from the borehole centerline and the azimuthal angle, θ, measured relative to the azimuth of the maximum horizontal stress. Additionally, λ is the dynamic Lamé parameter; μ is the dynamic shear modulus; ρ is the bulk density; ν is the static drained Poisson's ratio; E is the static drained Young's modulus; σᵥ, σ_{H}, and σₕ are the vertical stress, maximum horizontal stress, and minimum horizontal stress respectively; c₁₁₁, c₁₄₄, and c₁₅₅ are third order non-linear dynamic moduli; and R and p_{mud} are the borehole radius and the mud pressure, respectively.

Equations 2, 3, and 4 are subject to some assumptions. In particular, equations 2, 3, and 4 assume that the borehole is a vertical circular borehole immersed in an isotropic infinite homogenous medium, that one of the principal far field stresses is vertical, that the relationship between stress and strain is linear, that third order acoustoelasticity is valid, and that pore pressure is independent of “r” and “θ” at a given depth. The assumption that pore pressure is uniform at a given depth implies good mud cake and sufficient time for relaxation of pressures induced by the stress concentration applied to the borehole wall. Even when mudcake is good, induced pore pressures can occur when the maximum horizontal stress is not equal to the minimum horizontal stress.

The assumptions that the relation between stress and strain is linear and that pore pressure is uniform at a given depth can both be relaxed by using more advanced mathematical formulations, such as non-linear elastic equations, poroelastic equations, or other equations to estimate the stress. The consequence of the assumption that pore pressure is uniform at a given depth is that equations 2, 3, and 4 are independent of the pore pressure. This assumption means that the far field total stresses can be found by inverting radial profiles even when the pore pressure is unknown.

Additionally, equations 2, 3, and 4 are strictly valid at values of r, θ for which the directions of propagation and polarization of acoustical waves emitted by a sonic tool are aligned with principal stress axes. Equations 2, 3, and 4 are approximate for borehole acoustic waves that are not aligned in this manner.

Additionally, parameters λ, μ, ν, E, c₁₁₁, c₁₄₄, and c₁₅₅ are properties in an isotropic reference state. An assumption is made that an isotropic confining stress equal to ⅓ (σᵥ+σ_{H}+σₕ) was applied in the reference state. However, deriving similar equations for other reference states is straightforward.

Additionally, ρ is the local bulk density which varies near the borehole due to changes in volumetric strain. The local bulk density is related to the density in the reference state, ρ₀, by the equation.

ρ(1+εᵥ)=ρ₀ (5)

In equation 5, the parameter εᵥ is the local volumetric strain. The local volumetric strain vanishes in the far field. Thus, the density in the far field is the same as the density in the reference state. For small strains, the density near the borehole wall deviates only slightly from the reference value when the maximum horizontal stress does not equal the minimum horizontal stress, and is exactly equal to the reference value when the maximum horizontal stress is equal to the minimum horizontal stress. Thus, the density in the formation can be assumed to be uniform and equal to the density in the reference state.

The right hand sides of equations 2, 3, and 4 all adhere to a common form. Specifically, the right hand sides of equations 2, 3, and 4 adhere to the form:

$$α + \frac{β}{{x}^{2}} + \frac{γ}{{x}^{4}} \qquad ( 6 )$$

In equation 6, x is the dimensionless radius (r/R) and α, β, and γ are coefficients of sequential powers of

$$( \frac{1}{{x}^{2}} ) .$$

The coefficients α, β, and γ are expressions that are non-linear in the parameters θ, p_{mud}, λ, μ, ρ, ν, E, σᵥ, σ_{H}, σₕ, c₁₁₁, c₁₄₄, and c₁₅₅. In practice, all these parameters except θ, ρ, and p_{mud} are unknown.

The illustrative embodiments described herein provide a method for extracting values or constraints for one or more of the ten unknowns λ, μ, ν, E, σᵥ, σ_{H}, σₕ, c₁₁₁, c₁₄₄, and c₁₅₅. In a specific illustrative embodiment, the unknowns are deduced via simultaneous inversion.

From equations 2, 3, and 4 the radial profile for Vₚ, has γ=0, but for the other two radial profiles α, β, and γ, are in general non-zero. Thus, for a given radial profile of Vₛ or c₆₆, three equations can be constructed for the unknowns by finding the values of α, β, and γ that best matches the profile. For the case of Vₚ, two equations can be obtained. If radial profiles for Vₚ, Vₛ, and c₆₆ in the fast and slow shear wave directions are available, which is a total of three pairs of profiles, sixteen equations can be written for the unknowns. However, only nine of these equations are independent because the coefficients α, β, and γ are related in the following manner:

### For Vp:

α_{co}[θ=0]=α_{co}[θ=π/2]

β_{co}[θ=0]=−β_{co}[θ=λ/2] (7)

### For Vs:

γₛₕ[θ=0]=−γₛₕ[θ=π/2]

3αₛₕ[θ=0]−3αₛₕ[θ=π/2]−2γₛₕ[θ=0]=0 (8)

For c₆₆:

γ_{c6}[θ=0]=−γ_{c6}[θ=π/2]

3α_{c6}[θ=0]−3α_{c6}[θ=π/2]−2γ_{c6}[θ=0]=0 (9)

Subscripts “co”, “sh”, and “c6” are used to denote coefficients of the Vₚ, Vₛ and c₆₆ radial profiles respectively. In addition to equations 7, 8, and 9, the following relations between the coefficients and the Vₛ and c₆₆ radial profiles can be proven.

(αₛₕ[θ=0]−αₛₕ[θ=π/2])(β_{c6}[θ=0]+β_{c6}[θ=π/2])+(βₛₕ[θ=0]+βₛₕ[θ=π/2])(α_{c6}[θ=0]−α_{c6}[θ=π/2])=0 (10)

By virtue of equations 7-10, the number of independent equations that can be derived from the complete set of radial profiles is reduced to nine. Because ten unknowns exist, a unique solution is only possible if one of the unknowns is specified. Most frequently, the vertical stress, σᵥ, is known at least approximately from density logs. Consequently, the remaining unknowns can be constrained.

The following paragraphs provide an example of how inversion can proceed from approximate knowledge of the vertical stress. Although the following example provides one method of how inversion can proceed, other methods are also possible. For example, the inversions described herein can also be carried out directly from sonic dispersion curves of slowness versus frequency. Alternatively, the inversion can proceed from the two shear moduli corresponding to the fast and slow shear wave velocities or by using the shear wave velocity in the plane perpendicular to the borehole axis instead of c₆₆.

In the following numerical example, the inversion of simulated data is demonstrated. In this illustrative example, the parameters have the following values:

| | | | |
|---|---|---|---|
| E = 6.0 GPa | ν = 0.1 | μ = 3.78 GPa | λ = 0.687 GPa |
| p_{mud} = 2 MPa | σₕ = 3 MPa | σ_{H} = 4.5 MPa | σᵥ = 5 MPa |
| c111 = −9.55 TPa | c144 = −1.22 TPa | c155 = −2.05 TPa | ρ = |
| | | | 2.062 g/cm³ |

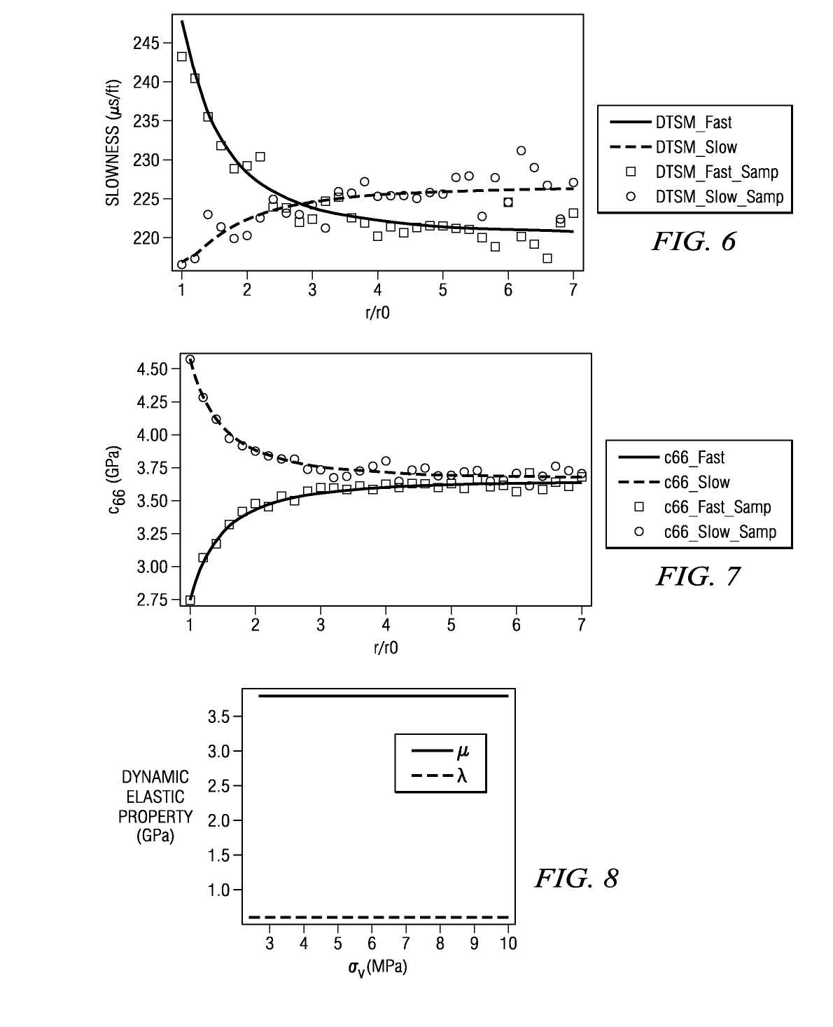

The corresponding radial profiles calculated using equations 2, 3, and 4 are shown in FIG. 5 through FIG. 7. Note that FIG. 5 and FIG. 6 show slownesses instead of velocities. Slowness is the inverse of velocity. The profiles in FIG. 5 through FIG. 7 were sampled at regular intervals and then random noise was added to produce the synthesized data shown in the figures. Both the exact and noisy samples were inverted for the ten unknowns λ, μ, ν, E, σᵥ, σ_{H}, σₕ, c₁₁₁, c₁₄₄, and c₁₅₅, subject to the constraint that 4.5 MPa<σᵥ<5.5 MPa. In other words, a ten percent margin of error was assumed for σᵥ.

For a case in which the data is exact, a solution was obtained by finding the values α, β, and γ that produce the best match to the data. This solution gave rise to a system of nine independent non-linear equations that were solved using a root finding scheme. Because ten unknowns existed, solutions were obtained at different values of the vertical stress, σᵥ.

Returning to FIG. 5, FIG. 5 is a graph of fast and slow radial profiles of compressional slowness, in accordance with an illustrative embodiment. FIG. 6 is a graph illustrating fast and slow radial profiles of shear slowness, in accordance with an illustrative embodiment. FIG. 7 is a graph illustrating fast and slow radial profiles of c₆₆, in accordance with an illustrative embodiment. In each of FIGS. 5-7, the graphs can be produced using software or hardware in a data processing system, such as data processing system 100 in FIG. 1, or data processing system 200 in FIG. 2. In each of FIGS. 5-7, profiles are calculated in fast and slow shear wave directions. Theoretical curves represented by the solid and dashed lines are sampled to produce the exact data. Noise was then added to produce synthetic data as shown by the squares and circles. The synthetic data was added for inversion. Both exact and noisy data were inverted.

FIG. 8 through FIG. 11 show the results. FIG. 8 through FIG. 10 show that unique solutions were obtained for λ, μ, ν, c₁₁₁₁, c₁₄₄, and c₁₅₅. In other words, these properties are independent of the vertical stress, σᵥ. The solutions are also correct in the sense that they are exactly equal to the values used to generate the simulated data. FIG. 11 is a graph illustrating results of deterministic inversion of exact data for stresses and the static Young's modulus in accordance with an illustrative embodiment. FIG. 11 shows that E, σ_{H}, and σₕ are non-unique. In other words, these parameters depend on the vertical stress, σᵥ. As shown in FIG. 11, the letters EDyn represent the dynamic Young's modulus. By applying the constraints on σᵥ, the following values were found for the parameters:

σₕ=3.0 MPa±0.17 MPa

σ_{H}=4.5 MPa±0.42 MPa

E=6.0 GPa±1 GPa

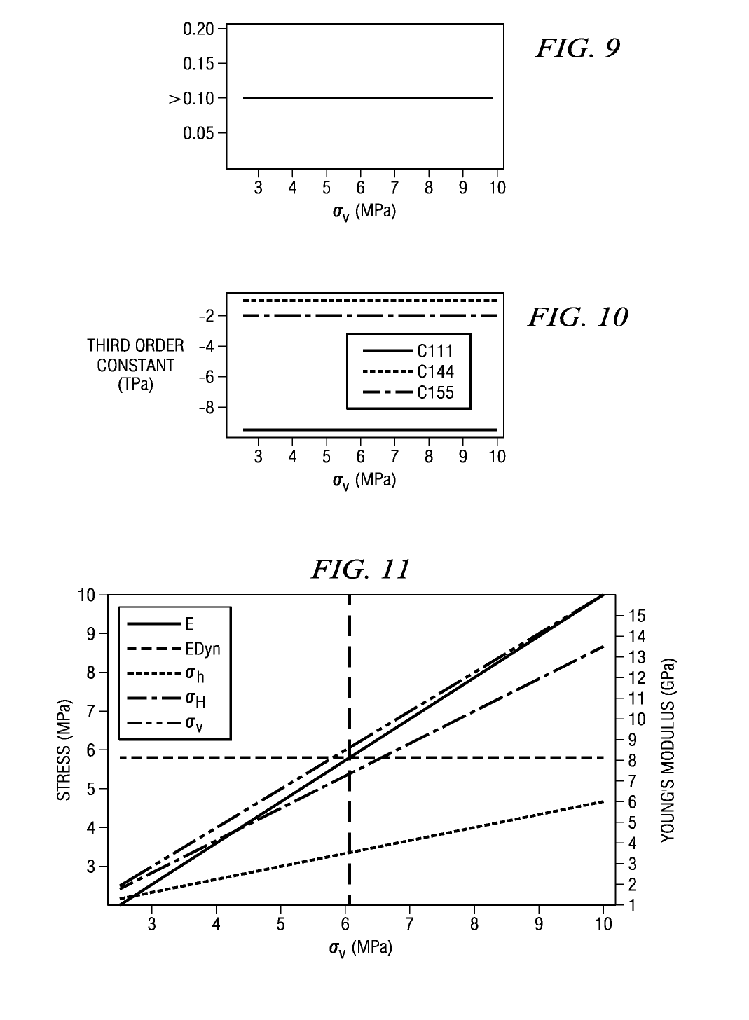

FIG. 8 is a graph showing results of deterministic inversion of exact data for two dynamic elastic properties in accordance with an illustrative embodiment. Specifically, FIG. 8 is a graph showing the results of deterministic inversion of exact data for the dynamic shear modulus, μ, and the dynamic Lame's constant, λ, in an isotropic reference stress state in accordance with an illustrative embodiment. FIG. 9 is a graph illustrating results of a deterministic inversion of exact data for the static Poisson's ratio in an isotropic reference stress state, in accordance with an illustrative embodiment. The graphs shown in FIG. 8 and FIG. 9 can be produced using hardware or software in a data processing system, such as data processing system 100 shown in FIG. 1, or data processing system 200 shown in FIG. 2. The solutions shown in FIG. 8 and FIG. 9 are expressed as functions of the vertical stress, av. The graph shown in FIG. 9 shows inferred values of μ as shown by the solid line and λ as shown by the dashed line. In FIG. 9, inferred values of v are shown by the dashed line.

FIG. 10 is a graph illustrating results of deterministic inversion of exact data for three third order nonlinear dynamic moduli in accordance with an illustrative embodiment. FIG. 11 is a graph illustrating results of deterministic inversion of exact data for stress and Young's modulus, in accordance with an illustrative embodiment. The graphs shown in FIGS. 10 and 11 can be produced using hardware or software in a data processing system, such as data processing system 100 shown in FIG. 1, or data processing system 200 shown in FIG. 2.

The solutions shown in FIG. 10 and FIG. 11 are expressed as functions of the vertical stress, σᵥ. FIG. 10 shows inferred values of c₁₁₁ as shown by the solid line, c₁₄₄ as shown by the dashed line, and c₁₅₅ as shown by the broken dashed line. FIG. 11 shows inferred values of E as shown by the solid line, EDyn as shown by the medium dashed line, σₕ as shown by the short dashed line, σ_{H} as shown by the alternately long and short dashed line, and σᵥ as shown by the alternately long and double short dashed line.

If the vertical stress, σᵥ, were known exactly, the solutions for E, σ_{H} and σₕ would be unique and exact. Therefore, for the ideal case in which radial profiles in σᵥ are exactly known, unique and exact solutions can be found for the remaining 9 unknowns. However if uncertainty exists in the vertical stress, σᵥ, then this uncertainty propagates into the solutions for E, σ_{H}, and σₕ.

The dynamic Young's modulus (EDyn) is calculated from the inferred values from λ and μ plotted in FIG. 11. By comparing this quantity with the static Young's modulus, E, additional bounds on the inferred quantities can be obtained by imposing the criterion that E is less than EDyn. Thus, for example, σₕ cannot exceed 3.4 MPa in this example, as shown by the dashed vertical line.

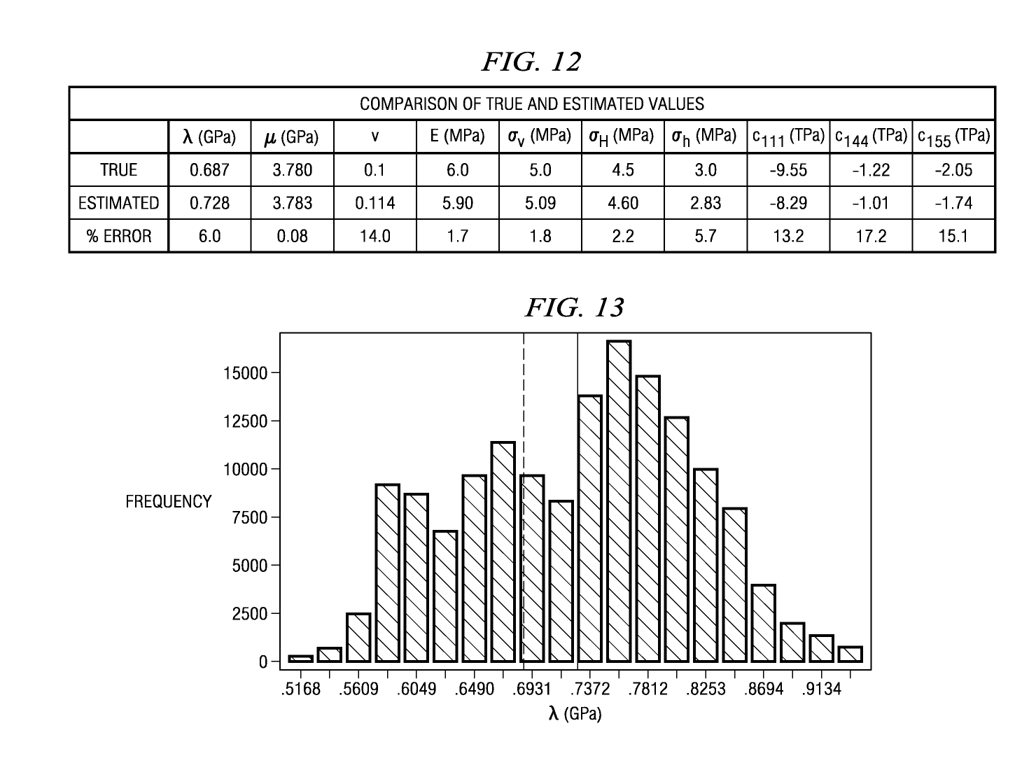

FIG. 12 is a table illustrating comparison of true and estimated values in accordance with an illustrative embodiment. The table shown in FIG. 12 can be implemented in a data processing system, such as data processing system 100 shown in FIG. 1, or data processing system 200 in FIG. 2. FIG. 12 is a table comparing true and estimated values of various parameters associated with equations 2, 3, and 4.

A Bayesian probabilistic approach was employed to invert the noisy data in FIG. 5 through FIG. 7. A prior probability distribution was constructed using boxcar probability functions to represent the previously specified constraints on the vertical stress, σᵥ, as well as broad constraints that were applied to the other unknowns. The likelihood probability function representing the degree of fit between the model (equations 2, 3, and 4) and the data was assumed to be Gaussian. The Markov Chain Monte Carlo technique was used to draw 150,000 samples from the posterior probability density function. Sample distributions for some of the unknowns are shown in FIGS. 13 through 16. In these figures the dashed and solid lines show the true and estimated (sample mean) values respectively. The inferred parameters and their associated errors are shown in the table of FIG. 12.

Satisfactory results can be seen in all cases with the possible exception of the non-linear elastic constants. Although the error in “ν” might appear to be high, this error can be seen within the context of conventional techniques for predicting the static Poisson's ratio from downhole logs. This quantity can be estimated from the dynamic Poisson's ratio derived directly from acoustic logs. However, dynamic and static Poisson's ratios frequently do not exhibit consistent relationships in laboratory tests. Thus, good correlations between these two properties are difficult to obtain. Consequently, the dynamic and static Poisson's ratios are often assumed to be identical. However, these properties can differ by more than a factor of two.

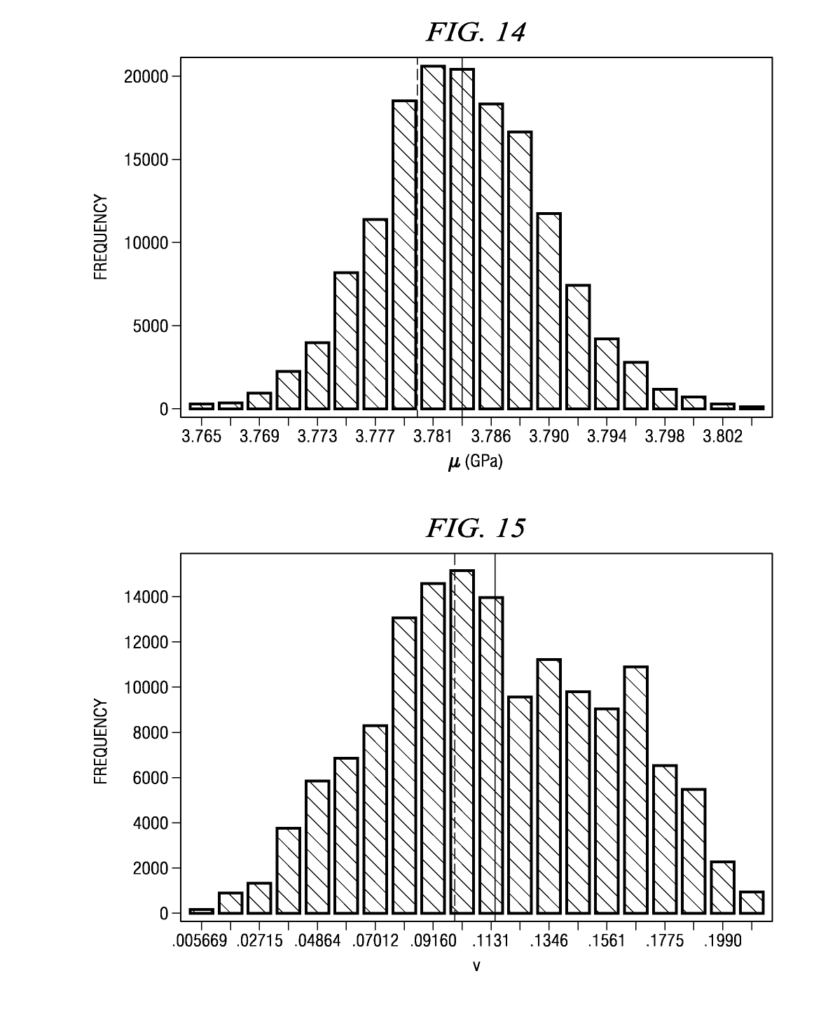

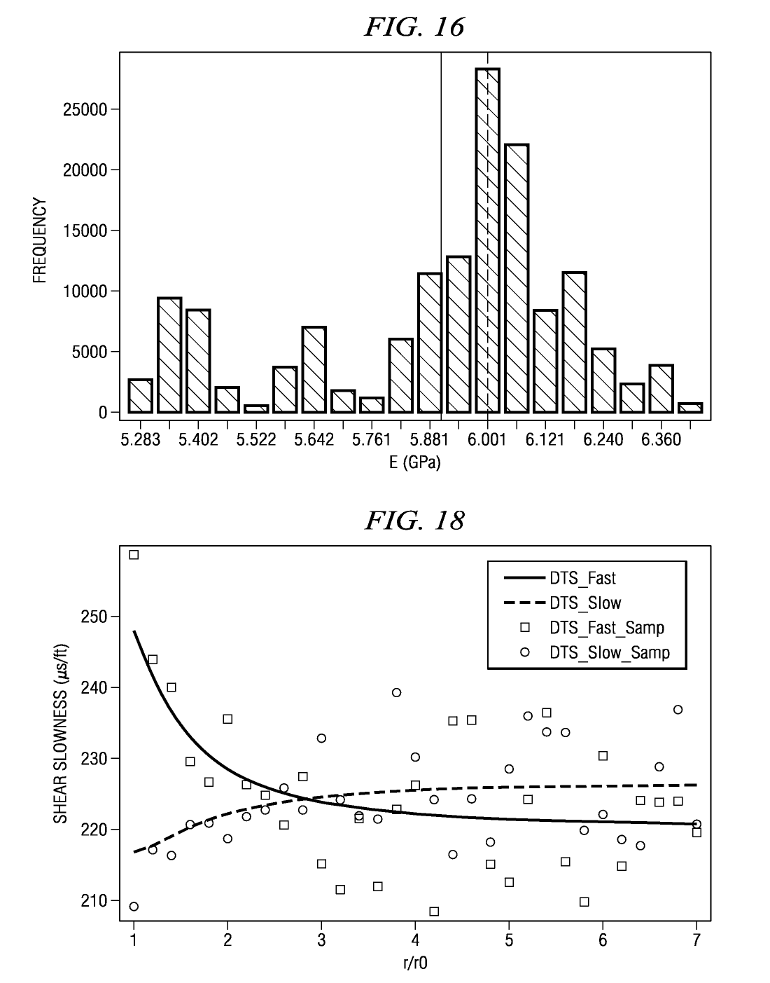

FIG. 13 is a graph illustrating sample distributions for a dynamic Lamé's constant, λ, derived from probabilistic inversion of noisy radial profile data, in accordance with an illustrative embodiment. FIG. 14 is a graph illustrating sample distributions for the dynamic shear modulus derived from probabilistic inversion of noisy radial profile data, in accordance with an illustrative embodiment. FIG. 15 is a graph illustrating sample distributions for the static drained Poisson's ratio derived from probabilistic inversion of noisy radial profile data, in accordance with an illustrative embodiment. FIG. 16 is a graph illustrating sample distributions for the static drained Young's modulus derived from probabilistic inversion of noisy radial profile data, in accordance with an illustrative embodiment. The graphs shown in FIGS. 13 through 16 can be implemented using a data processing system, such as data processing system 100 shown in FIG. 1, or data processing system 200 shown in FIG. 2.

FIG. 13 through FIG. 16 collectively show sample distributions for the corresponding parameters with respect to this first numerical example. In each of FIG. 13 through FIG. 16, the dashed and solid vertical lines show the true and estimated (sample mean) values respectively.

An additional theory for a non-ideal case is also presented. In the preceding example, the inversion was applied with the assumption that all six radial profiles were known. However, current processing algorithms are limited to measure four radial profiles; one compressional, one fast shear, one slow shear, and one c₆₆. Methods based on ray tracing are only able to extract compressional radial profiles along azimuths for which the compressional wave velocity increases with radial distance from the borehole. Using such methods, the measured compressional slowness radial profile represents an average of the compressional wave slowness distribution over these azimuths. The single measured c₆₆ profile is also an azimuthal average, however, the average is taken over all azimuths. The shear radial profiles are not subject to processing limitations and can be measured in both fast and slow directions.

By integrating equations 2 and 4 over appropriate azimuths, equations were derived to account for these limitations. Because equations 2 and 4 are only valid when the directions of propagation and polarization of acoustic waves are aligned with principal stress axes, both equations are integrated azimuthally at the borehole wall where such alignment occurs irrespective of azimuth. The integration leads to the following two expressions for the averaged Vₚ and c₆₆ measured at the borehole wall by an acoustic tool:

$$\begin{matrix}{Vp}_{wall} = \sqrt{\frac{λ + 2 μ}{ρ}} [ 1 + \frac{\begin{matrix}( 1 + v ) ( {σ}_{h} + {σ}_{H} - 2 {σ}_{v} ) \\ ( 2 {c}_{155} + 5 μ + 2 λ )\end{matrix}}{3 E ( λ + 2 μ )} + \frac{\begin{matrix}2 ( {c}_{111} - 4 {c}_{155} - 2 μ ) \\ ( 1 + v ) ( 2 v - 1 ) ( {σ}_{h} - {σ}_{H} )\end{matrix}}{π E ( λ + 2 μ )} ] & ( 11 ) \\ {c}_{66 wall} = μ - \frac{( 1 + v ) [ \begin{matrix}( {c}_{155} - {c}_{144} + 3 μ ) \\ ( {σ}_{h} + {σ}_{H} - 2 {σ}_{v} )\end{matrix} ]}{3 E} - \frac{( 1 + v ) μ ( 2 {p}_{mud} - {σ}_{h} - {σ}_{H} )}{E} & ( 12 )\end{matrix}$$

Deducing an expression for the far field compressional wave velocity measured by the tool is also possible, because this velocity tends to be a value that is constant for all azimuths as “r” (the radial distance from the borehole center) approaches infinity. Setting “r” to infinity in equation 2 yields the following equation:

$${Vp}_{far} = \sqrt{\frac{λ + 2 μ}{ρ}} [ 1 + \frac{\begin{matrix}( 1 + v ) ( {σ}_{h} + {σ}_{H} - 2 {σ}_{v} ) \\ ( 2 {c}_{155} + 5 μ + 2 λ )\end{matrix}}{3 E ( λ + 2 μ )} ] \qquad ( 13 )$$

Equations 11, 12, and 13 provide three independent equations for the unknown stresses and material properties. Other combinations of equations could be derived, for example, by considering acoustic wave propagation that is not aligned with principal stress axes. Fast and slow shear wave radial profiles can provide four additional independent equations when the interdependence of coefficients expressed by equation 8 is taken into account. Therefore, at any given depth in a borehole, a total of 7 independent equations are available for deducing ten unknowns.

Additional constraints are useful to make the problem more tractable. Examples of possible constraints include empirical relations between dynamic and static moduli, relations between far field principal stresses based on empirical or theoretical models, the use of contact theories to reduce the number of independent parameters, additional equations obtained by changing the borehole mud pressure, and assumptions about the spatial structure of rock properties along the borehole trajectory expressed using geostatistical or other methods. These possible constraints are exemplary only, as other constraints exist. The last constraint technique (assumptions about the spatial structure of rock properties) can be illustrated with a second numerical example.

In the second numerical example which follows, in order to acquire a sufficient number of equations to solve for all of the unknowns, the borehole is assumed to have penetrated a reasonably homogenous stratum of rock that is sufficiently thick to allow for significant stress variation over the section exposed to the borehole. Rigorous definitions of the terms “reasonably” and “significant” will not be attempted here. In practice, homogeneity can be assessed at least qualitatively from examination of geophysical and core data, and is possible to verify, a posteriori, whether the stress variation was significant enough to produce a satisfactory inversion.

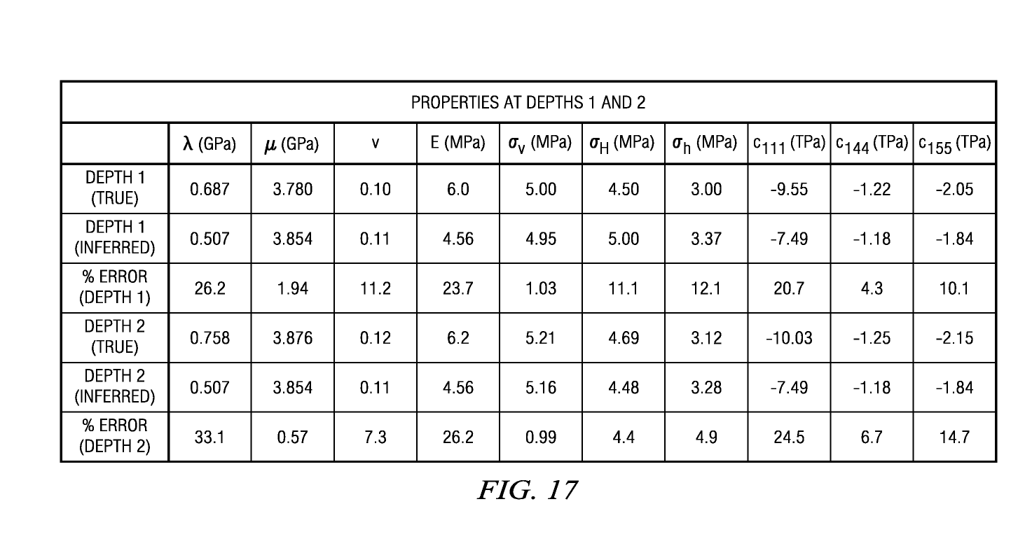

Radial profiles at two locations, Depth 1 and Depth 2, are jointly inverted in the following simulated example. Depth 1 was assumed to be shallower than Depth 2. The true material properties and stresses at both depths are shown in FIG. 17. The material properties vary slightly between the two depths. The changes in the principal stresses between the two depths are typical of a 30 ft interval, assuming an overburden gradient of 1 psi/ft and gradients of 0.6 and 0.9 psi/ft for σₕ and σ_{H} respectively. FIG. 17 omits the borehole mud pressures. These pressures were assumed to be known quantities in the inversion and were set equal to 2 MPa and 2.1 MPa at Depths 1 and 2 respectively, consistent with a mud pressure gradient of 0.5 psi/ft over a 30 ft depth.

FIG. 17 is a table illustrating actual and inferred properties at two different depths for various physical constants and stresses related to a rock formation in accordance with an illustrative embodiment. The data shown in FIG. 17 can be implemented in a data processing system, such as data processing system 100 shown in FIG. 1 or data processing system 200 shown in FIG. 2. Specifically, the data shown in FIG. 17 is used with respect to the second numerical example, especially with respect to equations 3, 11, 12, and 13 which are applied to invert noisy data.

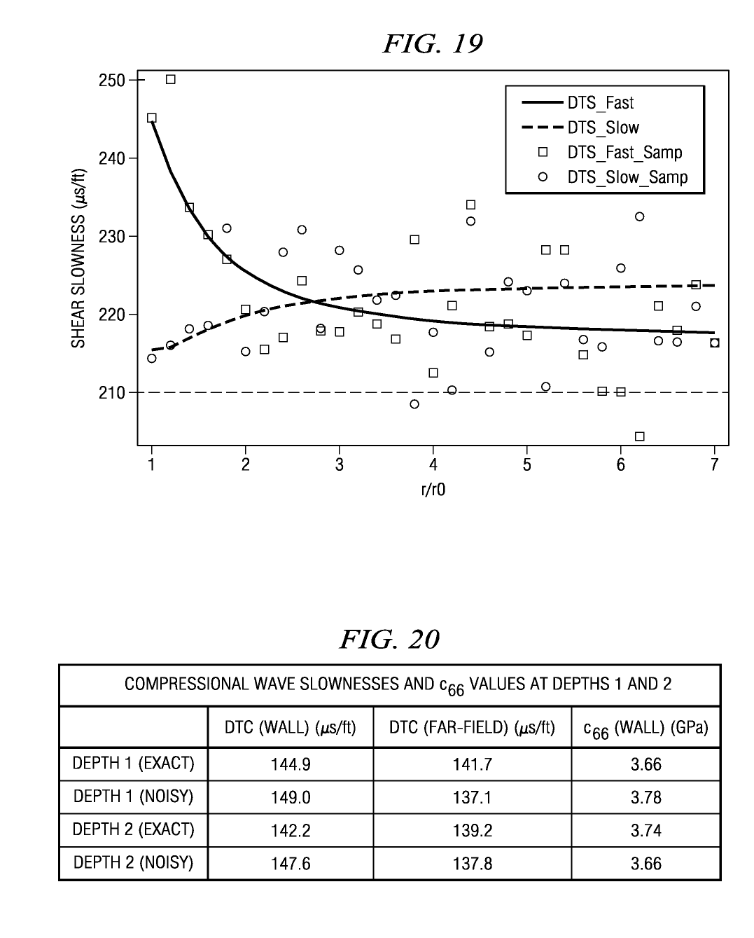

The true data shown in FIG. 17 is substituted into equations 3, 11, 12, and 13 and noisy synthetic sonic data was generated. This synthetic data was then inverted to retrieve the rock properties and stresses shown in FIG. 17. FIGS. 18 and 19 show the theoretical shear radial profiles along with the noisy synthetic samples used for inversion. A significant amount of noise was added to the samples in order to demonstrate the robustness of the illustrative embodiments described herein. The noise was produced using a random normal deviate with a zero mean and a standard deviation of three percent. FIG. 20 shows the exact and noisy synthetic data for the compressional slowness and c₆₆. For clean radial profiles, the accuracy of compressional slowness is expected to lie within two to three percent. However, thirty-eight percent of the noisy samples shown in FIGS. 18, 19, and 20 have errors exceeding three percent and twelve percent of the samples have errors exceeding five percent.

FIG. 18 is a graph illustrating radial profiles of shear slowness at a first depth, in accordance with an illustrative embodiment. FIG. 19 is a graph illustrating radial profiles of shear slowness at a second depth, in accordance with an illustrative embodiment. The graphs shown in FIGS. 18 and 19 can be implemented using a data processing system, such as data processing system 100 shown in FIG. 1 or data processing system 200 shown in FIG. 2. As shown in FIGS. 18 and 19, the profiles are calculated in fast and slow shear wave directions. Theoretical curves shown by the dashed and solid lines were sampled to produce exact data. Noise was then added to produce synthetic data (squares and circles) for inversion.

FIG. 20 is a table illustrating compressional wave slowness and c₆₆ values at two different depths, in accordance with an illustrative embodiment. The table shown in FIG. 20 can be implemented in a data processing system, such as data processing system 100 in FIG. 1, or data processing system 200 in FIG. 2. In particular, the table shown in FIG. 20 shows compressional wave slownesses, and c₆₆ values at two different depths, depth 1 and depth 2.

In carrying out the inversion, the material properties are assumed to be the same at both depths. This assumption is consistent with the supposition of spatial homogeneity and is approximately correct given the small spatial fluctuations in the actual properties shown in FIG. 17. Thus, the synthetic data is inverted jointly for the following unknowns:
At Depth 1: σᵥ₁, σ_{H1}, σₕ₁
At Depth 2: σ_{H2}, σₕ₂
At Both Depths: λ, μν, E, c₁₁₁, c_{144, and c}₁₅₅

The vertical stress at depth 2, σᵥ₂, was not explicitly inverted. An assumption was made that the difference between σᵥ₂ and σᵥ₁ was known from integration from the density log between the two depths. Thus, σᵥ₂ was derived by adding this increment to σᵥ₁. In summary, twelve unknowns were retrieved by solving fourteen independent equations (seven at each depth).

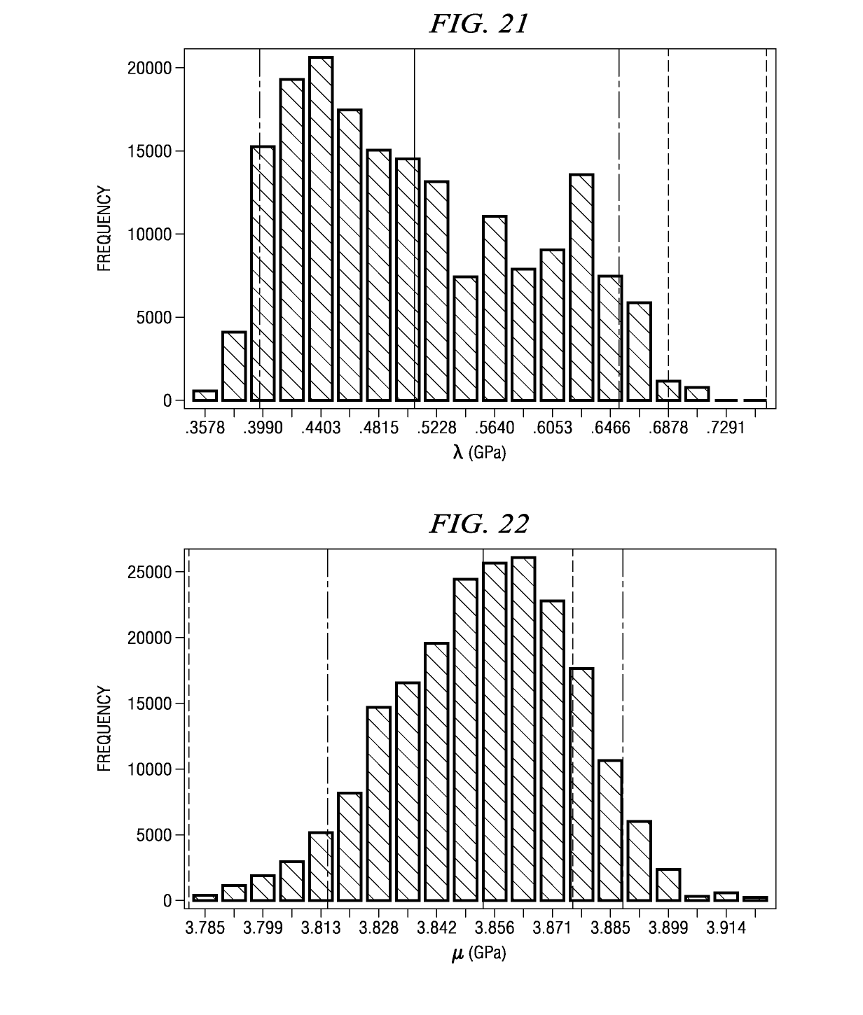

As before, a Bayesian inversion scheme was employed in order to account for uncertainty due to noise in the data. The vertical stress, σᵥ₁, was assumed to be known to within ten percent of its true value. The results are shown in Figure 21 through FIG. 32. The table shown in FIG. 17 summarizes the results (sample means) along with their errors relative to the true values. With the exceptions of λ, E, and c₁₁₁, the actual and inferred values agree to within fifteen percent. This result is satisfactory considering the noisiness of the data.

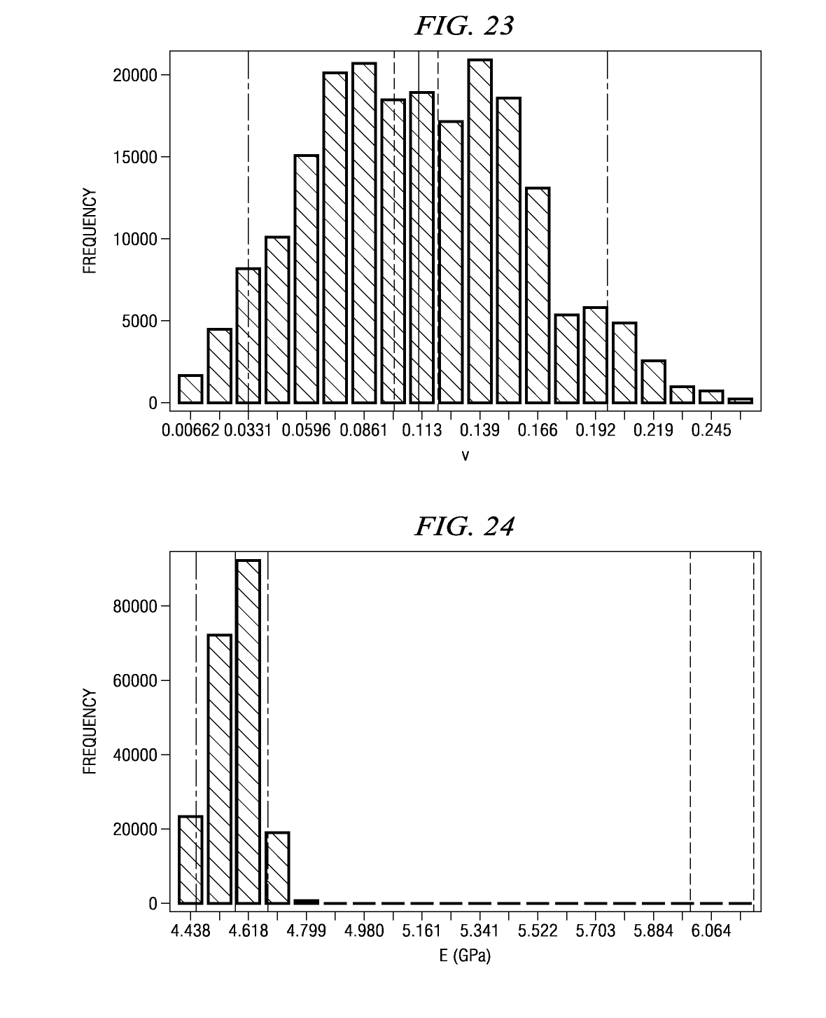

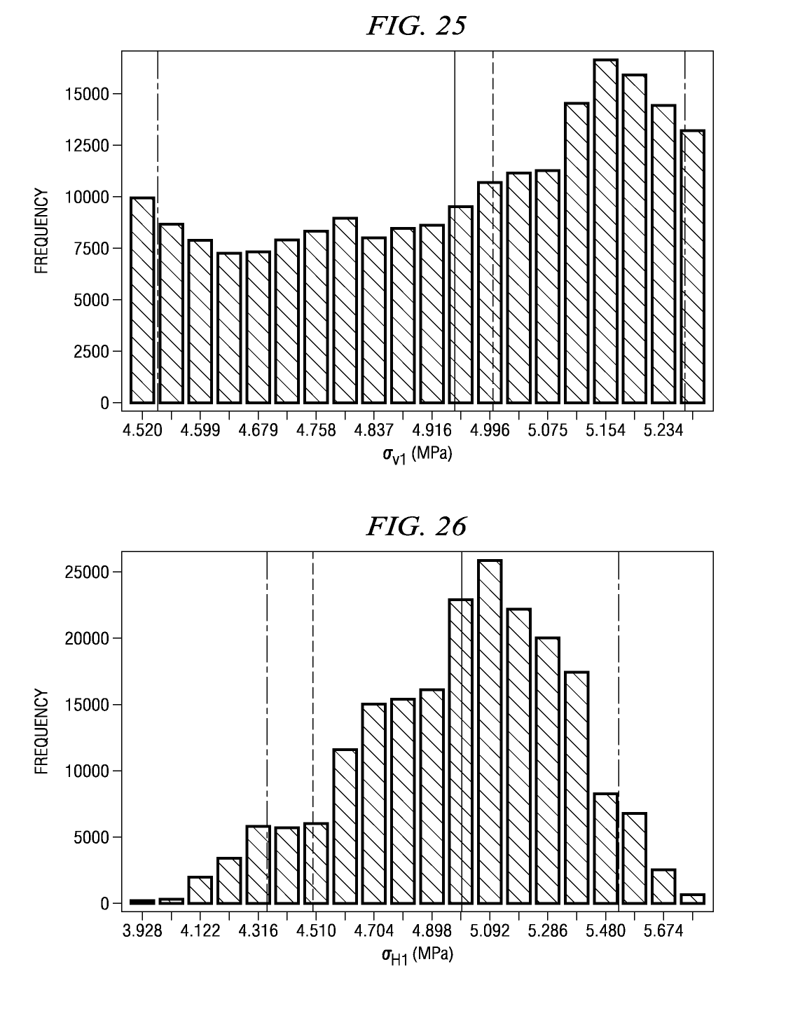

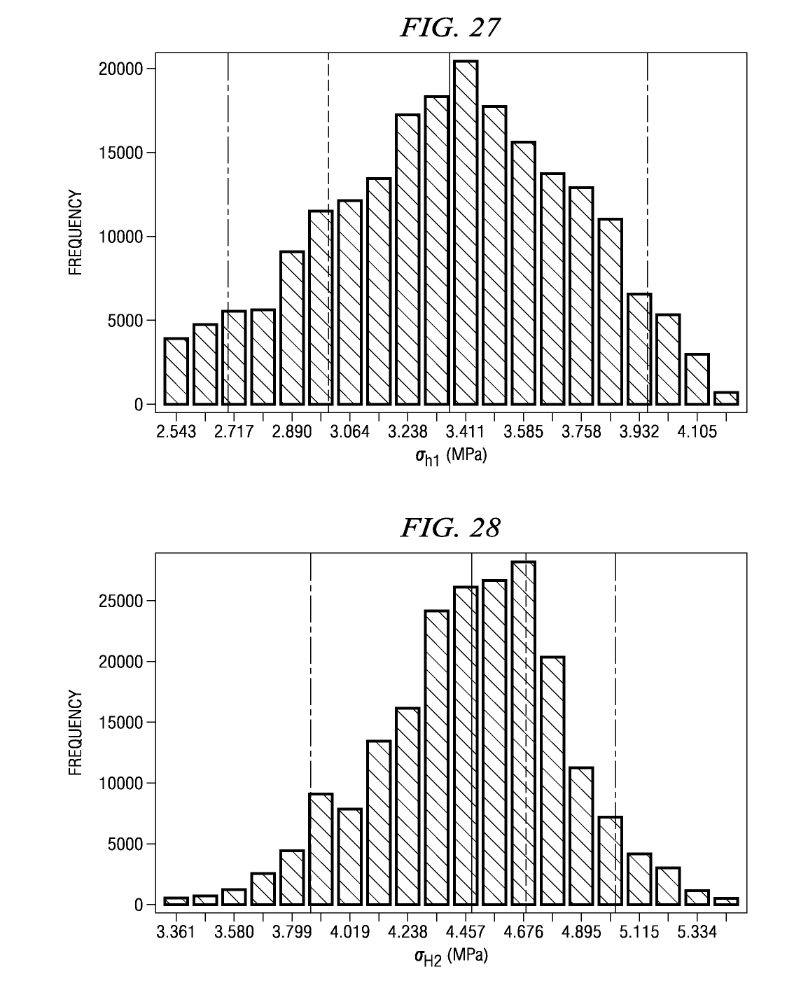

FIG. 21 is a graph illustrating sample distributions for Lamé's constant, λ, derived from probabilistic inversion of noisy radial profile data in accordance with an illustrative embodiment. FIG. 22 is a graph of sample distributions for the dynamic shear modulus derived from probabilistic inversion of noisy radial profile data, in accordance with an illustrative embodiment. FIG. 23 is a graph illustrating sample distributions for the static Poisson's ratio derived from probabilistic inversion of noisy radial profile data, in accordance with an illustrative embodiment. FIG. 24 is a graph illustrating sample distributions for the static Young's modulus derived from probabilistic inversion of noisy radial profile data, in accordance with an illustrative embodiment. FIG. 25 is a graph illustrating sample distributions for the vertical stress at depth 1 derived from probabilistic inversion of noisy radial profile data, in accordance with an illustrative embodiment. FIG. 26 is a graph illustrating sample distributions for the maximum horizontal stress at depth 1 derived from probabilistic inversion of noisy radial profile data, in accordance with an illustrative embodiment. Figure 27 is a graph illustrating sample distributions for the minimum horizontal stress at depth 1 derived from probabilistic inversion of noisy radial profile data, in accordance with an illustrative embodiment.

FIG. 28 is a graph illustrating sample distributions for the maximum horizontal stress at depth 2 derived from probabilistic inversion of noisy radial profile data, in accordance with an illustrative embodiment. FIG. 29 is a graph illustrating sample distributions for the minimum horizontal stress at depth 2 derived from probabilistic inversion of noisy radial profile data, in accordance with an illustrative embodiment.

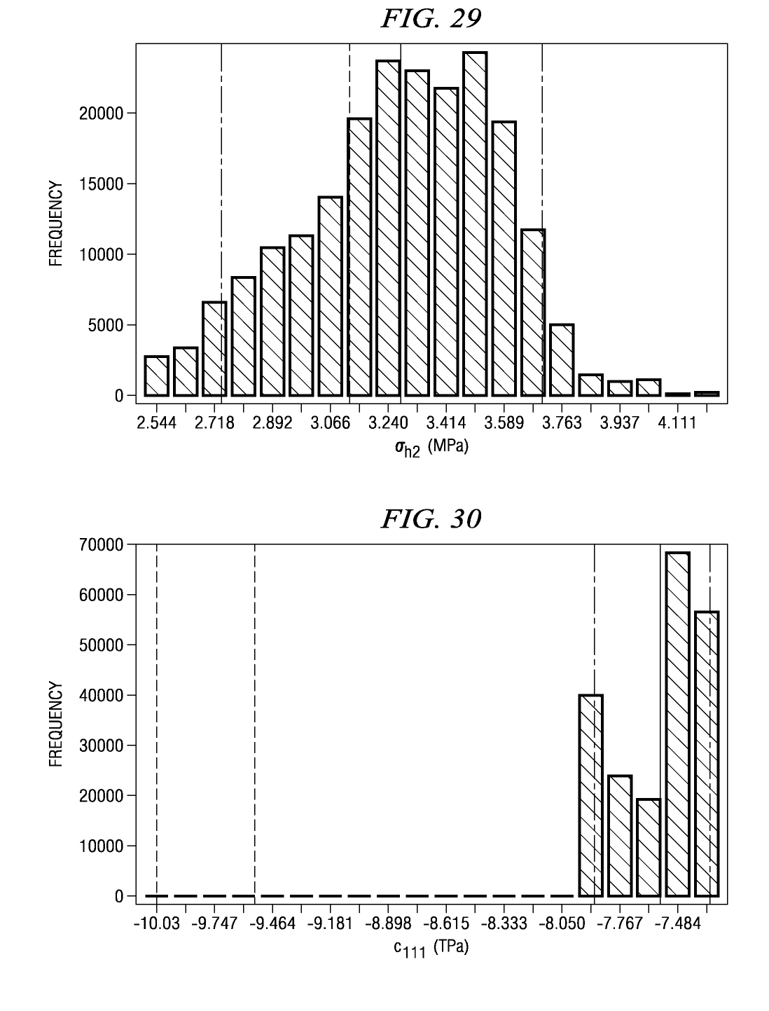

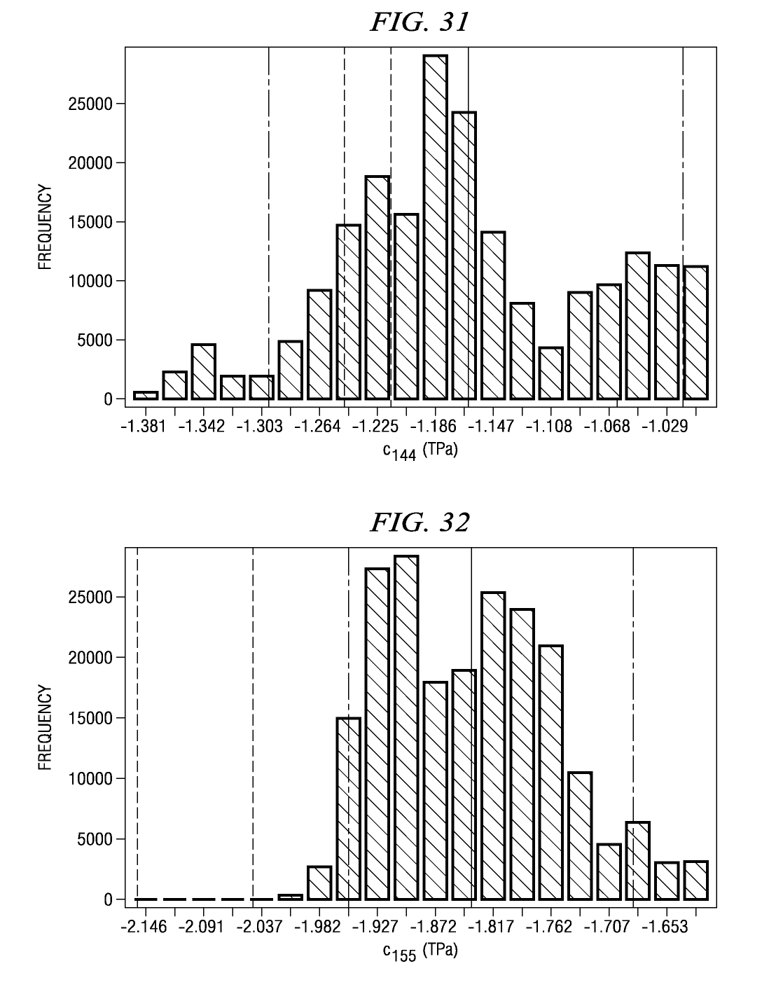

FIG. 30 is a graph illustrating sample distributions for the non-linear dynamic modulus c₁₁₁ derived from probabilistic inversion of noisy radial profile data, in accordance with an illustrative embodiment. FIG. 31 is a graph illustrating sample distributions for the non-linear dynamic modulus c₁₄₄ derived from probabilistic inversion of noisy radial profile data, in accordance with an illustrative embodiment. FIG. 32 is a graph illustrating sample distributions for the non-linear dynamic modulus c₁₅₅ derived from probabilistic inversion of noisy radial profile data, in accordance with an illustrative embodiment.

The graphs shown in FIG. 21 through FIG. 32 can be implemented or created in a data processing system, such as data processing system 100 in Figure 1, or data processing system 200 in FIG. 2. FIG. 21 through FIG. 32 provide the results of the second numerical example for noisy data. In each of FIG. 21 through FIG. 32, the dash lines show the true values at depths 1 and 2. The solid line shows the estimated sample mean value, and the broken dash lines show ninety percent confidence limits of the values.

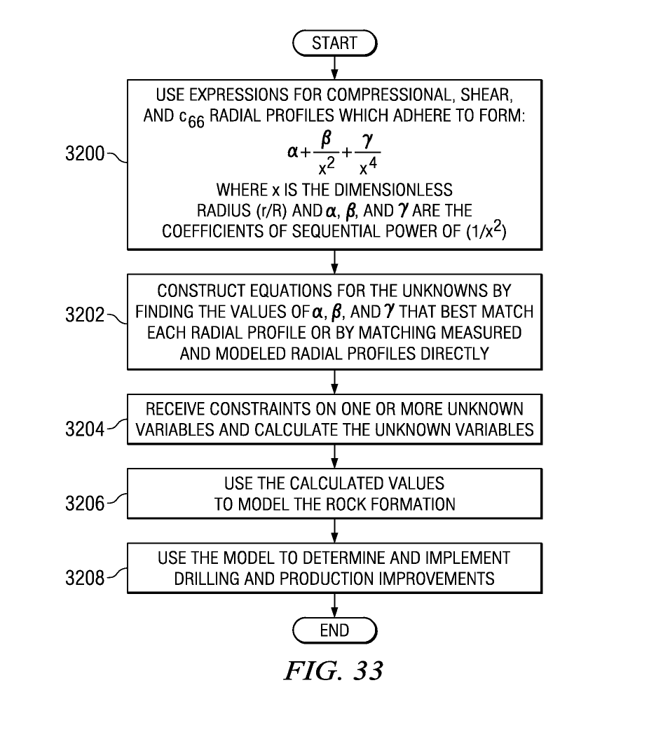

FIG. 33 is a flow chart illustrating a method of using a model of a borehole to determine and implement production improvements for the borehole, in accordance with an illustrative embodiment. The process shown in FIG. 33 can be implemented in a data processing system, such as data processing system 100 shown in FIG. 1, or data processing system 200 shown in FIG. 2. The equations and values described with respect to FIG. 33 can be seen in equations 2, 3, 4, and 6 as described with respect to FIG. 4 through FIG. 32. The process shown in FIG. 33 can be implemented using hardware or software or a combination of hardware and software. The process shown in FIG. 33 can be implemented using hardware, software, or measuring tools, or a combination of hardware, software, and/or measuring tools. Together the hardware, software, and/or measuring tools, as appropriate, can be referred to as a system.

The process begins as the system uses expressions for compressional, shear, and c₆₆ radial profiles which adhere to the form:

$$α + \frac{β}{{x}^{2}} + \frac{γ}{{x}^{4}} ,$$

where x is a dimensionless radius (r/R) and α, β and γ are coefficients of sequential powers of

$$( \frac{1}{{x}^{2}} )$$

(step 3200). The system then constructs nine independent equations for the unknowns at each depth location by finding the values of α, β, and γ that best match the profiles. Alternatively, the nine independent equations do not have to be constructed explicitly. Instead, the solution for the unknowns is found by directly matching modeled and observed radial profiles. Solving the problem in this manner does not alter the number of independent equations that are being solved. Noisy data can be accommodated using this direct matching procedure by employing a stochastic inversion scheme, such as a Bayesian inversion scheme, to solve for the unknowns.

In the event that a full complement of compressional, shear, and c₆₆ radial profiles are not available, the number of independent equations at each depth will be less than nine. In that case, additional constraints, such as assumptions about the spatial distribution of formation properties with respect to depth, can be used to make the problem tractable.

In the most general case, the number of unknown variables is 10. However in certain cases there may be less than 10 unknown variables, as some of the variables may be known from independent measurements. In that case, the additional constraints described above might not be needed in order to make the problem tractable. In any case, the system constructs equations for the unknowns by finding the values of α, β, and γ that best match each radial profile or by matching measured and modeled radial profiles directly (step 3202).

The system receives constraints on one or more unknown variables and calculates the unknown variables (step 3204). The system then uses the calculated values to model the rock formation (step 3206). The system uses the model to determine and implement drilling and production improvements (step 3208). In part, drilling improvements include the use of mud of an optimum weight to support the walls of the borehole during drilling. In part, production improvements for the well include perforating the well, and deliberately introducing fractures into the sides of the borehole in order to cause additional fluid to flow from the rock into the borehole. The process terminates thereafter.

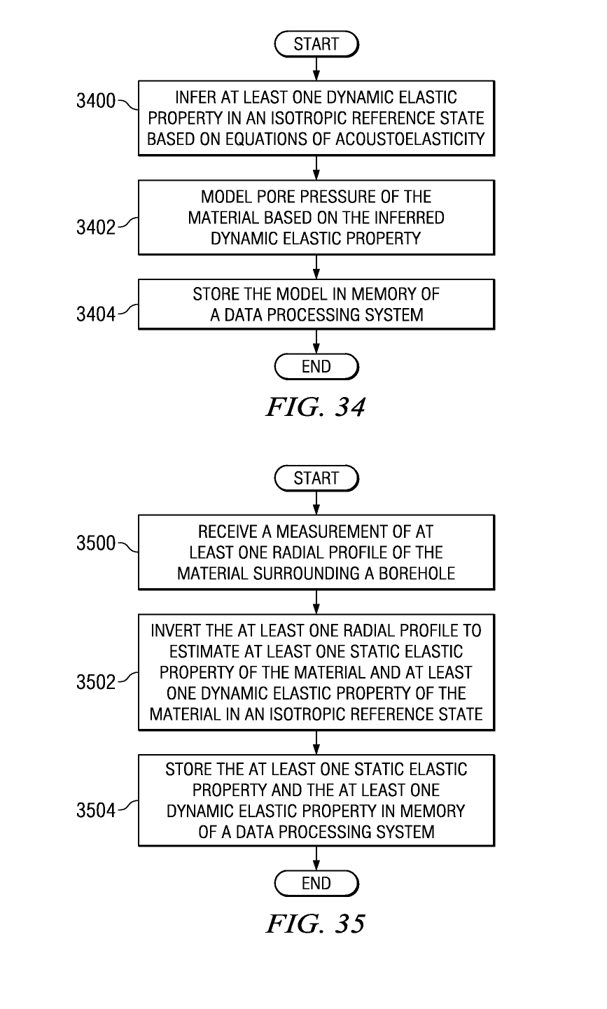

FIG. 34 is a flowchart illustrating a method of modeling the pore pressure in a rock formation, in accordance with an illustrative embodiment. The process shown in FIG. 34 can be implemented in a data processing system, such as data processing system 100 shown in FIG. 1, or data processing system 200 shown in FIG. 2. The process shown in FIG. 34 can be implemented using hardware, software, or measuring tools, or a combination of hardware, software, and/or measuring tools. Together the hardware, software, and/or measuring tools, as appropriate, can be referred to as a system.

The process shown in FIG. 34 involves the use of an inferred dynamic property in an isotropic reference state to estimate pore pressure in the formation. The process begins as the system infers at least one dynamic elastic property in an isotropic reference state based on equations of acoustoelasticity (step 3400). The system then models pore pressure in the material based on the inferred dynamic elastic property (step 3402). The system stores the model in the memory of a data processing system (step 3404). The process terminates thereafter. Note the technique is not restricted to just the rocks near the borehole, as the equations of acoustoelasticity may be applied to estimate dynamic elastic properties in an isotropic reference state at locations far away from the borehole using seismic measurements or other data.

FIG. 35 is a flowchart illustrating a method of determining at least one static elastic property and at least one dynamic elastic property in an isotropic reference state, in accordance with an illustrative embodiment. The process shown in FIG. 35 can be implemented in a data processing system, such as data processing system 100 shown in FIG. 1, or data processing system 200 shown in FIG. 2. The process shown in FIG. 35 can be implemented using hardware, software, or measuring tools, or a combination of hardware, software, and/or measuring tools. Together the hardware, software, and/or measuring tools, as appropriate, can be referred to as a system.

The process shown in FIG. 35 can be implemented in conjunction with the process shown in FIG. 34, before, during, or after, the process shown in Figure 34, to generate additional information. Thus, for example, the processes shown in FIG. 34 and FIG. 35 can be combined into a single process.

The process begins as the system receives a measurement of at least one radial profile of the material surrounding a borehole (step 3500). The system then inverts the at least one radial profile to estimate at least one static elastic property of the material, and at least one dynamic elastic property of the material in an isotropic reference state (step 3502). The system stores the at least one static elastic property and the at least one dynamic elastic property in the memory of a data processing system (step 3504). The process terminates thereafter.

Thus, the methods and devices described herein provide for a quantitative method of modeling the stresses and material properties of a rock formation at the site of the borehole. The illustrative methods described herein avoid the problem of taking core samples of rock and transporting the core samples of rock to a laboratory for measurements in order to determine the desired properties of the rock. In this manner, the illustrative embodiments described herein provide a method of in situ modeling of the geomechanical properties of a formation. For this reason, the illustrative embodiments described herein are faster and more cost efficient than any known method for measuring geomechanical properties of a rock formation.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

Although the foregoing is provided for purposes of illustrating, explaining and describing certain embodiments of the invention in particular detail, modifications and adaptations to the described methods, systems and other embodiments will be apparent to those skilled in the art and may be made without departing from the scope or spirit of the invention.

What is claimed is:

1. A computer-implemented method of estimating mechanical properties and stresses of material surrounding a borehole, the computer-implemented method comprising:
inferring in situ, a static Young's modulus and a static Poisson's ratio of the material surrounding the borehole;
generating a geomechanical model of the material using the static elastic property; and
storing the geomechanical model in a memory of a data processing system.

2. The computer-implemented method of claim 1 further comprising using one of the static elastic property or the geomechanical model to determine at least one production improvement for the borehole.

3. A computer-implemented method of modeling stresses and mechanical properties of rocks surrounding a borehole, the computer-implemented method comprising:
inferring at least one dynamic elastic property in an isotropically stressed reference state for a rock formation, wherein the inference is made on the basis of at least one of sonic tool data, seismic data, and combinations thereof;
using the at least one dynamic elastic property in an isotropically stressed reference state to estimate pore pressure;
inverting for at least one static elastic property in an isotropically stressed reference state of the material based on a measurement taken by a sonic tool;
generating a borehole model using the at least one dynamic elastic property and the at least one static elastic property; and
storing the borehole model in a memory of a data processing system.

4. The computer-implemented method of claim 3 further comprising:
inverting at least one radial profile to accomplish determining the at least one static elastic property of the material.

5. The computer-implemented method of claim 3 further comprising using the borehole model to determine at least one production improvement for the well.

6. A computer-implemented method of determining stresses and material properties around a borehole of a well, the computer-implemented method comprising:
specifying a first set of equations for compressional radial profiles, a second set of equations for shear radial profiles, and third set of equations for c₆₆ radial profiles, wherein the first set of equations, second set of equations, and third set of equations all adhere to a first form comprising
$$α + \frac{β}{{x}^{2}} + \frac{γ}{{x}^{4}} ,$$
wherein “x” is a dimensionless radius comprising a fourth equation of a second form comprising (r/R), wherein “r” is a radial distance from a center of the borehole and “R” is a radius of the borehole, and wherein α, β, and γ are coefficients of sequential powers of a fifth equation of a third form comprising (1/x²);
constructing independent equations of the first form for unknown variables by finding values of α, β, and γ that best match the compressional radial profile, the shear radial profile and the c₆₆ radial profile;
constraining at least one of the unknown variables;
inverting for at least one of the unknown variables using at least one of the independent equations;
employing at least one of a deterministic inversion scheme and a probabilistic inversion schemes to expedite inversion;
responsive to a full complement of radial profiles being unavailable, employing one or more constraints to solve for at least one of the unknown variables; and
storing corresponding solved variables in a memory of a data processing system.

7. The computer-implemented method of claim 6 further comprising:
inverting for the unknown variables by matching modeled and predicted radial profiles without recourse to the intermediate step of finding values α, β, and γ.

8. The computer-implemented method of claim 6 wherein the first set of equations, the second set of equations, and the third set of equations are all based on an elastic solution for stresses around the borehole.

9. The computer-implemented method of claim 6 further comprising constructing additional dependent equations for the unknown variables.

10. The computer-implemented method of claim 6 wherein:
the first set of equations is derived from:
$$Vp ( r , θ ) = \sqrt{\frac{λ + 2 μ}{ρ}} [ \begin{matrix}1 + \frac{\begin{matrix}( 1 + v ) ( {σ}_{h} + {σ}_{H} - 2 {σ}_{v} ) \\ ( 2 {c}_{155} + 5 μ + 2 λ )\end{matrix}}{3 E ( λ + 2 μ )} + \\ \frac{\begin{matrix}( {c}_{111} - 4 {c}_{155} - 2 μ ) ( 1 + v ) \\ ( 2 v - 1 ) ( {σ}_{h} - {σ}_{H} ) Cos ( 2 θ )\end{matrix}}{E ( λ + 2 μ )} \frac{{R}^{2}}{{r}^{2}}\end{matrix} ] ;$$
the second set of equations is derived from:
$$Vs ( r , θ ) = \sqrt{\frac{μ}{ρ}} [ \begin{matrix}1 + \frac{( 1 + v ) [ \begin{matrix}( {c}_{155} - {c}_{144} + 6 μ ) ( {σ}_{h} + {σ}_{H} - 2 {σ}_{v} ) + \\ ( 3 {c}_{155} - 3 {c}_{144} + 6 μ ) ( {σ}_{h} - {σ}_{H} ) Cos ( 2 θ )\end{matrix} ]}{12 μ E} + \\ \frac{( 1 + v ) [ \begin{matrix}( {c}_{155} - {c}_{144} + 2 μ ) ( {σ}_{h} + {σ}_{H} - 2 {p}_{mud} ) + \\ 4 ( {c}_{144} v - {c}_{155} ( 1 - v ) - μ - λ ( 1 - 2 v ) ) \\ ( {σ}_{h} - {σ}_{H} ) Cos ( 2 θ )\end{matrix} ]}{4 μ E} \frac{{R}^{2}}{{r}^{2}} + \\ \frac{3 ( - {c}_{144} + {c}_{155} + 2 μ ) ( 1 + v ) ( {σ}_{h} - {σ}_{H} ) Cos ( 2 θ )}{4 μ E} \frac{{R}^{4}}{{r}^{4}}\end{matrix} ] ;$$
the third set of equations is derived from:
$${c}_{66} ( r , θ ) = μ - \frac{( 1 + v ) [ \begin{matrix}( {c}_{155} - {c}_{144} + 3 μ ) ( {σ}_{h} + {σ}_{H} - 2 {σ}_{v} ) - \\ 3 μ ( {σ}_{h} - {σ}_{H} ) Cos ( 2 θ )\end{matrix} ]}{3 E} - \frac{( 1 + v ) [ \begin{matrix}- μ ( {σ}_{h} + {σ}_{H} - 2 {p}_{mud} ) + \\ ( 2 {c}_{155} + 2 λ ( 1 - 2 v ) + 8 μ - 4 {c}_{155} v - 12 μ v ) \\ ( {σ}_{h} - {σ}_{H} ) Cos ( 2 θ )\end{matrix} ]}{E} \frac{{R}^{2}}{{r}^{2}} + \frac{3 ( 1 + v ) μ ( {σ}_{h} - {σ}_{H} ) Cos ( 2 θ )}{E} \frac{{R}^{4}}{{r}^{4}} ;$$
wherein Vp(r,θ) comprises a compressional wave velocity, Vs(r,θ) comprises a shear wave velocity, and c₆₆(r,θ) comprises a modulus of a shear wave propagating in a plane perpendicular to the borehole axis;
wherein Vp(r,θ), Vs(r,θ), and c₆₆(r,θ) are expressed as functions of a radial distance from the borehole centerline, r, and an azimuthal angle, θ;
wherein the azimuthal angle is an angle measured relative to an azimuth of the maximum horizontal stress;
wherein λ is a dynamic Lamé's constant, μ is a dynamic shear modulus, ρ is a bulk density, ν is a static drained Poisson's ratio, E is a static drained Young's modulus, σᵥ is a vertical stress, σ_{H} is a maximum horizontal stress, σₕ is a minimum horizontal stress, and wherein λ, μ, ν, and E, are referenced to an isotropic reference state;
wherein c₁₁₁, c₁₄₄, and c₁₅₅ are third-order nonlinear elastic constants, and wherein c₁₁₁, c₁₄₄, and c₁₅₅ are referenced to the isotropic reference state; and
wherein P_{mud} is a mud pressure and R is the radius of the borehole.
